(19) United States
(12) Patent Application Publication
(10) Pub. No.: US 2010/0150510 A1
(43) Pub. Date: Jun. 17, 2010

(54) FLEXIBLE OPTICAL WAVEGUIDE, PROCESS FOR ITS PRODUCTION, AND EPOXY RESIN COMPOSITION FOR FLEXIBLE OPTICAL WAVEGUIDES

(75) Inventors: Shimpei Sato, Suita-shi (JP); Kozo Tajiri, Sanda-shi (JP); Yoko Matsui, Sendai-shi (JP); Tomomi Makino, Ashiya-shi (JP)

Correspondence Address: WENDEROTH, LIND & PONACK, L.L.P., 1030 15th Street, N.W.,, Suite 400 East, Washington, DC, 20005-1503, US

(73) Assignee: NIPPON SHOKUBAI CO., LTD

(21) Appl. No.: 12/312,214

(22) PCT Filed: Oct. 30, 2007
(86) PCT No.: PCT/JP2007/071122

§ 371 Date: Apr. 30, 2009

(30) Foreign Application Priority Data
Oct. 31, 2006 (JP) 2006-296522
Nov. 21, 2006 (JP) 2006-314785
Apr. 25, 2007 (JP) 2007-116091
Apr. 27, 2007 (JP) 2007-119202

(51) Int. Cl. G02B 6/10; G02B 6/02; C08G 59/02

(52) U.S. Cl. 385/130; 427/163.2; 528/418; 385/141

(57) ABSTRACT

The present invention provides a flexible optical waveguide in which at least one of a lower cladding layer, a core layer, and an upper cladding layer is composed of an epoxy film formed using an epoxy resin composition containing a polyglycidyl compound having a polyalkylene glycol chain(s) and at least two glycidyl groups or an epoxy film having a glass transition temperature (Tg) of 100° C. or lower, a process for its production, and an epoxy resin composition for flexible optical waveguides.

### TECHNICAL FIELD

The present invention relates to a flexible optical waveguide, a process for its production, and an epoxy resin composition for flexible optical waveguides.

### BACKGROUND ART

Along with the practical applications of optical transmission systems, techniques relevant to optical waveguides as their basic components have drawn much attention. An optical waveguide has, typically, an embedded type structure in which a core layer having a high refractive index is surrounded with a cladding layer having a low refractive index, or a ridge type structure in which a core layer having a high refractive index is formed on a lower cladding layer having a low refractive index and an upper cladding layer is an air layer. Thus, light incoming to the optical waveguide is transmitted in the core layer while being reflected at the interface between the core layer and the cladding layers or at the interface between the core layer and the air layer.

As the constituent materials of optical waveguides, there have been known inorganic materials such as quartz glass and semiconductors. On the other hand, production of optical waveguides using various types of polymers has been investigated and developed. The polymers, which are organic materials, are advantageous in that coating and heat treatment can be carried out at normal pressure in the step of film formation and therefore the apparatus and production steps can be simplified, in contrast to the inorganic materials.

As the material of polymer optical waveguides, polymethyl methacrylate (PMMA) has usually been used because it has high light transparency, and besides this polymer, polyimides have highly been expected because they have high glass transition temperatures (Tgs) and are excellent in flexibility and heat resistance, and therefore, are durable to soldering.

However, because polyimides are expensive, it has been attempting to produce optical waveguides using more inexpensive epoxy resins. For example, Patent Documents 1 and 2 disclose optical waveguides produced using ultraviolet curable resins containing aliphatic cyclic epoxy resins, bisphenol type epoxy resins, or brominated epoxy resins as essential ingredients. Further, Patent Document 3 discloses an optical waveguide produced using a mixture of an epoxy ring-containing monomer or oligomer and a polymerization initiator.

However, in general, epoxy resins have a property such that they are hard and brittle. That is, epoxy films obtained from epoxy resins are poor in flexibility, are extremely weak to bending, and cause cracks to become easily ruptured when they are bent. Therefore, it has been difficult to produce optical waveguides with flexibility, that is, flexible optical waveguides, using epoxy resins.

On the other hand, there have recently been developed opto-electronic hybrid integrated modules each comprising an optical waveguide and an electronic circuit, both formed on a single substrate. For example, Patent Document 4 discloses an opto-electronic wiring board obtained by attaching an optical waveguide film to a multi-layered wiring board with an adhesive. Further, Patent Document 5 discloses an opto-electronic wiring board obtained by attaching optical waveguide parts formed on a transparent substrate to an electronic circuit board with an adhesive. Further, Patent Document 6 discloses an opto-electronic hybrid integrated board obtained by attaching an optical waveguide film to an electronic circuit board with an adhesive.

However, the opto-electronic hybrid integrated modules each obtained by attaching an optical waveguide film to an electronic circuit board with an adhesive in this manner have a problem that the electronic circuit board and the optical waveguide film are easily separated from each other at the time of a wet heat test. Further, in order to lead light emitted from a light emitting device mounted on an electronic circuit board to an optical waveguide, this light needs to pass through an adhesive layer, at which time light scattering is caused because of a mismatch in refractive index between the optical waveguide film and the adhesive layer, and therefore, there is a problem that the waveguide loss of the optical waveguide becomes high. Further, even if an opto-electronic hybrid integrated module has flexibility to a certain extent, in the case where an adhesive layer exists, there is also a problem that the module is weak in bending, and therefore, the electronic circuit board and the optical waveguide film are easily separated from each other at the time of a bending test.

Thus, Patent Document 7 discloses an opto-electronic hybrid integrated flexible module obtained by previously producing epoxy resin films to be a lower cladding layer, a core layer, and an upper cladding layer of an optical waveguide, successively vacuum laminating these epoxy resin films onto a copper-clad polyimide substrate, and then curing the resulting films for directly forming an optical waveguide film on an electron circuit board without using an adhesive.

However, in such an opto-electronic hybrid integrated flexible module, epoxy resin films to be a lower cladding layer, a core layer, and an upper cladding layer of an optical waveguide need to be separately produced, and after these epoxy resin films are vacuum laminated onto a copper-clad polyimide substrate, the resulting film needs to be cured and a base film needs to be separated, and therefore, there is a problem that production steps become complicated and production costs becomes high.

Accordingly, it has been required to obtain a flexible optical waveguide which enables easy production of an opto-electronic hybrid integrated flexible module and which comprises an optical waveguide film formed directly on a substrate without using an adhesive, and a process for its production in a simple and easy manner.

Patent Document 1: Japanese Patent Laid-Open Publication (Kokai) No. Hei 6-273631

Patent Document 2: Japanese Patent Laid-Open Publication (Kokai) No. Hei 7-159630

Patent Document 3: Japanese Patent Laid-Open Publication (Kokai) No. Hei 8-271746

Patent Document 4: Japanese Patent Laid-Open Publication (Kokai) No. 2001-15889

Patent Document 5: Japanese Patent Laid-Open Publication (Kokai) No. 2002-189137

Patent Document 6: Japanese Patent Laid-Open Publication (Kokai) No. 2004-341454

Patent Document 7: Japanese Patent Laid-Open Publication (Kokai) No. 2006-22317

### DISCLOSURE OF THE INVENTION

Under the above circumstances, an object to be solved by the present invention is to provide a flexible optical waveguide which is excellent in flexibility and durable to bending, although the optical waveguide is composed of an epoxy resin(s); a process for its production; and an epoxy composition for flexible optical waveguides; and to further provide a flexible optical waveguide, in which an optical waveguide film can directly be formed on a substrate without using an adhesive or any other agent and which is excellent in flexibility of the optical waveguide film, including the substrate, as well as excellent in adhesiveness between the substrate and the optical waveguide film; and a process for its production in a simple and easy manner.

The present inventors have made various studies, and as a result, they have found that if at least one of a lower cladding layer, a core layer, and an upper cladding layer is composed of an epoxy resin film formed using an epoxy resin composition containing a specific epoxy resin or an epoxy film having a glass transition temperature (Tg) of 100° C. or lower, the optical waveguide film shows excellent flexibility, and further, the optical waveguide film can directly be formed on a substrate composed of a polyimide film without using an adhesive or any other agent and an epoxy film constituting the lower cladding layer shows excellent adhesiveness to the polyimide film constituting the substrate. These findings have led to the completion of the present invention.

That is, the present invention, in a first aspect, provides a flexible optical waveguide comprising a lower cladding layer, a core layer formed on the lower cladding layer, and an upper cladding layer formed on the lower cladding layer and the core layer in a manner of embedding the core layer therein, wherein at least one of the lower cladding layer, the core layer, and the upper cladding layer is composed of an epoxy film formed using an epoxy resin composition containing a polyglycidyl compound having a polyalkylene glycol chain(s) and at least two glycidyl groups.

In this flexible optical waveguide, each of the lower cladding layer, the core layer, and the upper cladding layer may preferably be composed of an epoxy film formed using an epoxy resin composition containing a polyglycidyl compound having a polyalkylene glycol chain(s) and at least two glycidyl groups.

Alternatively, in this flexible optical waveguide, the lower cladding layer may preferably be composed of an epoxy film formed using an epoxy resin composition containing a polyglycidyl compound having a polyalkylene glycol chain(s) and at least two glycidyl groups on a substrate composed of a polyimide film. In this flexible optical waveguide, each of the core layer and the upper cladding layer may more preferably be composed of an epoxy film formed using an epoxy resin composition containing a polyglycidyl compound having a polyalkylene glycol chain(s) and at least two glycidyl groups.

In these flexible optical waveguides, the polyglycidyl compound may preferably be a diglycidyl ether of polytetramethylene ether glycol.

Further, the present invention, in a second aspect, provides a flexible optical waveguide comprising a lower cladding layer, a core layer formed on the lower cladding layer, and an upper cladding layer formed on the lower cladding layer and the core layer in a manner of embedding the core layer therein, wherein at least one of the lower cladding layer, the core layer, and the upper cladding layer is composed of an epoxy film having a glass transition temperature (Tg) of 100° C. or lower and the waveguide loss of the flexible optical waveguide is 0.24 dB/cm or lower.

In this flexible optical waveguide, each of the lower cladding layer, the core layer, and the upper cladding layer may preferably be composed of an epoxy film having a glass transition temperature (Tg) of 100° C. or lower.

In these flexible optical waveguides, the epoxy film may preferably be formed using an epoxy resin composition containing a polyglycidyl compound having a polyalkylene glycol chain(s) and at least two glycidyl groups. In these flexible optical waveguides, the polyglycidyl compound may preferably be a diglycidyl ether of polytetramethylene ether glycol.

Further, the present invention provides a process for producing a flexible optical waveguide according to the first aspect, comprising steps of: forming a lower cladding layer; forming a core layer on the lower cladding layer; and forming an upper cladding layer on the lower cladding layer and the core layer in a manner of embedding the core layer therein, wherein at least one of the lower cladding layer, the core layer, and the upper cladding layer is formed using an epoxy resin composition containing a polyglycidyl compound having a polyalkylene glycol chain(s) and at least two glycidyl groups.

The present invention further provides an epoxy resin composition for flexible optical waveguides, comprising a polyglycidyl compound having a polyalkylene glycol chain(s) and at least two glycidyl groups, the composition having a refractive index after curing of from 1.45 to 1.65.

In this epoxy resin composition, the polyglycidyl compound may preferably be a diglycidyl ether of polytetramethylene ether glycol.

In the flexible optical waveguide of the present invention, at least one of the lower cladding layer, the core layer, and the upper cladding layer is composed of an epoxy resin film formed using an epoxy resin composition containing a specific epoxy resin or an epoxy film having a glass transition temperature (Tg) of 100° C. or lower, the flexible optical waveguide is excellent in flexibility and durable to bending, and therefore, it can be bent at 180 degrees with a radius of 1 mm and when waveguide loss is measured in a state that the flexible optical waveguide is bent at 90 degrees with a radius of 10 mm or bent at 180 degrees with a radius of 1 mm and then turned back to the previous state, the waveguide loss measured in such a state is not changed from the waveguide loss measured before being bent.

Further, in the case where the flexible optical waveguide of the present invention comprises a substrate composed of a polyimide film, because the polyimide film constituting the substrate is excellent in flexibility, and in addition to this, at least one of the lower cladding layer, the core layer, and the upper cladding layer, all of which are formed on the substrate, is composed of an epoxy film formed using an epoxy composition containing a specific epoxy resin, the flexible optical waveguide is excellent in flexibility and durable to bending. In particular, in the case where each of the lower cladding layer, the core layer, and the upper cladding layer is composed of an epoxy film formed using an epoxy composition containing a specific epoxy resin, the flexible optical waveguide can be bent at 180 degrees with a radius of 1 mm. Further, the flexible optical waveguide of the present invention is excellent in adhesiveness between the substrate and the optical waveguide film and shows high wet heat resistance even after it is allowed to stand still for a long time under high temperature and high humidity environments. Further, the flexible optical waveguide of the present invention can realize opto-electronic hybrid integrated flexible modules because a polyimide film constituting the substrate is excellent in heat resistance.

In the process for producing a flexible optical waveguide according to the present invention, there is no need to involve a step of forming a film constituting a substrate, in the case where the flexible optical waveguide comprises no substrate, and therefore, the optical waveguide can be formed in a simple and easy manner and production costs can remarkably be saved.

Further, in the process for producing a flexible optical waveguide according to the present invention, there is no need to include a step of forming an adhesive layer or any other layer between a substrate and a lower cladding layer, in the case where the flexible optical waveguide comprises a substrate, and in addition to this, only a lower cladding layer, a core layer, and an upper cladding layer are necessary to be successively formed on a substrate, and therefore, an optical waveguide film can be formed on the substrate in a simple and easy manner and production costs can remarkably be saved.

The epoxy resin composition for flexible optical waveguides according to the present invention comprises a specific epoxy resin, and therefore, the epoxy resin composition can provide an epoxy film excellent in flexibility and durable to bending. Further, the adjustment of the amount of epoxy resin to be contained makes it possible to arbitrarily adjust the refractive index of an epoxy film in a prescribed range, and therefore, the epoxy resin composition is useful for producing a flexible optical waveguide.

### BRIEF DESCRIPTION OF THE DRAWINGS

FIG. 1 is a cross sectional view schematically showing a typical example of the flexible optical waveguide of the present invention.

FIG. 2 is a cross sectional view schematically showing another typical example of the flexible optical waveguide of the present invention.

FIG. 3 is a step drawing schematically showing one process for producing the flexible optical waveguide shown in. FIG. 1.

FIG. 4 is a step drawing schematically showing one process for producing the flexible optical waveguide shown in FIG. 2.

FIG. 5 is a step drawing schematically showing another process for producing the flexible optical waveguide shown in FIG. 2.

FIG. 6 is a chart showing a ¹³C-solid NMR spectrum of an epoxy resin composition (1) for cladding layers after curing.

FIG. 7 is a chart showing a ¹³C-solid NMR spectrum of a cured material of a glycidyl ether of polytetramethylene ether glycol.

### BEST MODE FOR CARRYING OUT THE INVENTION

<<Flexible Optical Waveguide>>

The flexible optical waveguide of the present invention is, in a first aspect, a flexible optical waveguide comprising a lower cladding layer, a core layer formed on the lower cladding layer, and an upper cladding layer formed on the lower cladding layer and the core layer in a manner of embedding the core layer therein, wherein at least one of the lower cladding layer, the core layer, and the upper cladding layer is composed of an epoxy film formed using an epoxy resin composition containing a polyglycidyl compound having a polyalkylene glycol chain(s) and at least two glycidyl groups.

In this flexible optical waveguide, each of the lower cladding layer, the core layer, and the upper cladding layer may preferably be composed of an epoxy film formed using an epoxy resin composition containing a polyglycidyl compound having a polyalkylene glycol chain(s) and at least two glycidyl groups.

Alternatively, in this flexible optical waveguide, the lower cladding layer may preferably be composed of an epoxy film formed using an epoxy resin composition containing a polyglycidyl compound having a polyalkylene glycol chain(s) and at least two glycidyl groups on a substrate composed of a polyimide film. In this flexible optical waveguide, each of the core layer and the upper cladding layer may more preferably be composed of an epoxy film formed using an epoxy resin composition containing a polyglycidyl compound having a polyalkylene glycol chain(s) and at least two glycidyl groups.

In these flexible optical waveguides, the polyglycidyl compound may preferably be a diglycidyl ether of polytetramethylene ether glycol.

Further, the flexible optical waveguide of the present invention is, in a second aspect, a flexible optical waveguide comprising a lower cladding layer, a core layer formed on the lower cladding layer, and an upper cladding layer formed on the lower cladding layer and the core layer in a manner of embedding the core layer therein, wherein at least one of the lower cladding layer, the core layer, and the upper cladding layer is composed of an epoxy film having a glass transition temperature (Tg) of 100° C. or lower and the waveguide loss of the flexible optical waveguide is 0.24 dB/cm or lower.

In this flexible optical waveguide, each of the lower cladding layer, the core layer, and the upper cladding layer may preferably be composed of an epoxy film having a glass transition temperature (Tg) of 100° C. or lower.

In these flexible optical waveguides, the glass transition temperature (Tg) of an epoxy film may usually be 100° C. or lower, preferably 80° C. or lower, more preferably 60° C. or lower, and still more preferably 50° C. or lower. The lower limit of the glass transition temperature (Tg) is not particularly limited; however, it is about −60° C. The glass transition temperature (Tg) of an epoxy film as used herein means the glass transition temperature (Tg) of an epoxy resin composition after curing and is a value obtained by measurement using a differential scanning calorimeter (e.g., product name: DSC 220, available from Seiko Instruments Inc.) under the heating condition of 20° C./min in a nitrogen atmosphere.

The waveguide loss of these flexible optical waveguides may usually be 0.24 dB/cm or lower, preferably 0.22 dB/cm or lower, more preferably 0.20 dB/cm or lower, or still more preferably 0.18 dB/cm or lower. The lower limit of the waveguide loss is not particularly limited; however, it is about 0.05 dB/cm. The waveguide loss is a value obtained by measurement using a cut-back method as shown in Examples described below.

In these flexible optical waveguides, the 5% weight decrease temperature of an epoxy film may preferably be 200° C. or higher, more preferably 250° C. or higher, and still more preferably 300° C. or higher. The upper limit of the 5% weight decrease temperature is not particularly limited; however, it is about 500° C. The 5% weight decrease temperature of an epoxy film as used herein means the 5% weight decrease temperature of an epoxy resin composition after curing and is a value obtained by measurement using a TG/DTA simultaneous measuring apparatus (e.g., product name: DTG-50, available from Shimadzu Corporation) under the heating condition of 10° C./min in a nitrogen atmosphere.

In these flexible optical waveguides, each of the epoxy films may preferably be formed using an epoxy resin composition containing a polyglycidyl compound having a polyalkylene glycol chain(s) and at least two glycidyl groups. In these flexible optical waveguides, the polyglycidyl compound may more preferably be a diglycidyl ether of polytetramethylene ether glycol.

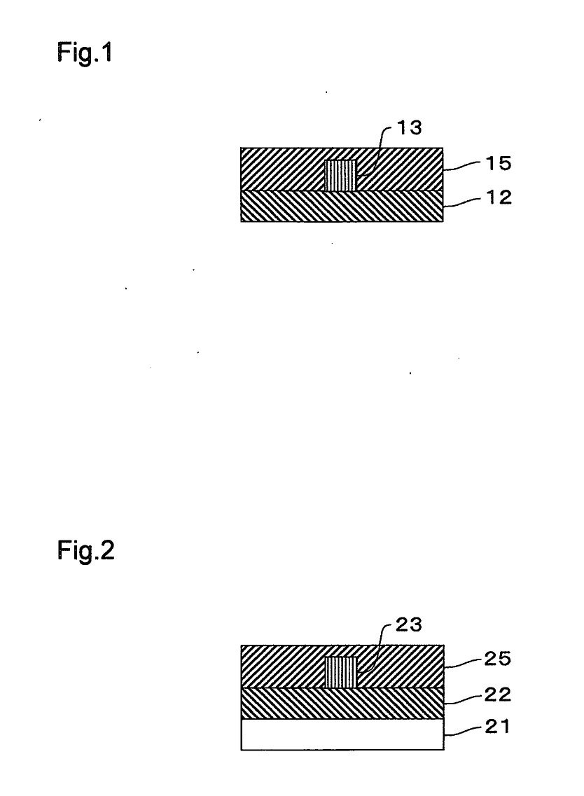

A typical example of the flexible optical waveguide of the present invention is shown in FIG. 1. The flexible optical waveguide of the present invention is not limited to this typical example, and its structure and composition may appropriately be modified or varied. As shown in FIG. 1, an upper cladding layer 15 is formed on a lower cladding layer 12 in such a manner that a core layer 13 is embedded therein. The core layer 13 and the upper cladding layer 15 are directly adhered onto the lower cladding layer 12 without forming an adhesive layer or any other layer interposed therebetween. At least one of the lower cladding layer 12, the core layer 13, and the upper cladding layer 15 is composed of an epoxy film formed using an epoxy resin composition containing a polyglycidyl compound having a polyalkylene glycol chain(s) and at least two glycidyl groups. Preferably, each of the lower cladding layer 12, the core layer 13, and the upper cladding layer 15 is composed of an epoxy film formed using an epoxy resin composition containing a polyglycidyl compound having a polyalkylene glycol chain(s) and at least two glycidyl groups. In FIG. 1, only one core layer 13 is formed; however, two or more core layers may be formed according to the applications of a flexible optical waveguide and other factors. Further, although the core layer 13 is formed in the form of a line extending along the vertical direction to the paper of the drawing, it may be formed into a prescribed pattern according to the applications of a flexible optical waveguide and other factors. Further, the flexible optical waveguide of the present invention may comprise, for example, a protection film, a separation film, or any other film on the upper side of the upper cladding layer 15, if necessary, so long as the flexibility of the flexible optical waveguide is not deteriorated.

Another typical example of the flexible optical waveguide of the present invention is shown in FIG. 2. The flexible optical waveguide of the present invention is not limited to this typical example, and its structure and composition may appropriately be modified or varied. As shown in FIG. 2, first, a lower cladding layer 22 is formed on a substrate 21. The lower cladding layer 22 is directly adhered onto the substrate 21 without forming an adhesive layer or any other layer interposed therebetween. Then, an upper cladding layer 25 is formed on the lower cladding layer 22 in such a manner that a core layer 23 is embedded therein. The core layer 23 and the upper cladding layer 25 are directly adhered onto the lower cladding layer 22 without forming an adhesive layer or any other layer interposed therebetween. The substrate 21 is composed of a polyimide film. At least one of the lower cladding layer 22, the core layer 23, and the upper cladding layer 25 is composed of an epoxy film formed using an epoxy resin composition containing a polyglycidyl compound having a polyalkylene glycol chain(s) and at least two glycidyl groups. The lower cladding layer 22 may preferably be composed of an epoxy film formed using an epoxy resin composition containing a polyglycidyl compound having a polyalkylene glycol chain(s) and at least two glycidyl groups. Further, each of the core layer 23 and the upper cladding layer 25 may more preferably be composed of an epoxy film formed using an epoxy resin composition containing a polyglycidyl compound having a polyalkylene glycol chain(s) and at least two glycidyl groups. In FIG. 2, only one core layer 23 is formed; however, two or more core layers may be formed according to the applications of a flexible optical waveguide and other factors. Further, although the core layer 23 is formed in the form of a line extending along the vertical direction to the paper of the drawing, it may be formed into a prescribed pattern according to the applications of a flexible optical waveguide and other factors. Further, the flexible optical waveguide of the present invention may comprise, for example, a protection film, a separation film, or any other film on the upper side of the upper cladding layer 25, if necessary, so long as the flexibility of the flexible optical waveguide is not deteriorated.

<Epoxy Resin Composition>

In the flexible optical waveguide of the present invention, an epoxy film constituting at least one of the lower cladding layer, the core layer, and the upper cladding layer is formed using an epoxy resin composition containing a polyglycidyl compound having a polyalkylene glycol chain(s) and at least two glycidyl groups. Therefore, the epoxy film constituting at least one of the lower cladding layer, the core layer, and the upper cladding layer is excellent in flexibility and durable to bending.

Further, in the flexible optical waveguide of the present invention, in the case where a lower cladding layer is composed of an epoxy film formed using an epoxy resin composition containing a polyglycidyl compound having a polyalkylene glycol chain(s) and at least two glycidyl groups on a substrate composed of a polyimide film, the epoxy film constituting the lower cladding layer is excellent in flexibility and durable to bending as well as excellent in adhesiveness to the polyimide film constituting the substrate.

An epoxy film formed using an epoxy resin composition containing a polyglycidyl compound having a polyalkylene glycol chain(s) and at least two glycidyl groups may specifically be obtained from an epoxy resin composition containing a polyglycidyl compound having a polyalkylene glycol chain(s) and at least two glycidyl groups and either an amine type curing agent or a cationic polymerization initiator. This epoxy resin composition may contain, if necessary, a bisphenol type epoxy resin and/or an alicyclic epoxy resin. The respective ingredients of the epoxy resin composition will be described below in detail.

(Polyglycidyl Compound having a Polyalkylene Glycol Chain(s) and at Least Two Glycidyl Groups)

As described above, in the flexible optical waveguide of the present invention, an epoxy film constituting at least one of the lower cladding layer, the core layer, and upper cladding layer is formed using an epoxy resin composition containing a polyglycidyl compound having a polyalkylene glycol chain(s) and at least two glycidyl groups.

With respect to a polyglycidyl compound having a polyalkylene glycol chain(s) and at least two glycidyl groups, oxyalkylene groups constituting the polyalkylene glycol chain(s) may be oxyalkylene groups each having preferably from 2 to 12 carbon atoms, more preferably from 2 to 8 carbon atoms, still more preferably from 3 to 6 carbon atoms, and most preferably 4 carbon atoms. These oxyalkylene groups may be of the linear or branched type and may have at least one substituent group. Further, these oxyalkylene groups may be all the same oxyalkylene groups or may be combinations of oxyalkylene groups of the different types. The number of repeating oxyalkylene groups constituting the polyalkylene glycol chain(s) may preferably be from 1 to 100, more preferably from 1 to 50, and still more preferably from 1 to 30.

Specific examples of the polyglycidyl compound having a polyalkylene glycol chain(s) and at least two glycidyl groups may include diglycidyl ethers of polyether polyols such as polyethylene ether glycol, polypropylene ether glycol, polytetramethylene ether glycol, and polypentamethylene ether glycol; diglycidyl ethers of copolyether polyols such as copoly(tetramethylene-neopentylene)ether diol, copoly(tetramethylene-2-methylbutylene)ether diol, copoly(tetramethylene-2,2-dimethylbutylene)ether diol, and copoly(tetramethylene-2,3-dimethylbutylene)ether diol; and triglycidyl ethers of aliphatic polyols, such as trimethylolpropane triglycidyl ester. In these polyglycidyl compounds, diglycidyl ethers of polyether polyols may be preferred and diglycidyl ethers of polytetramethylene ether glycol may particularly be preferred.

The polyglycidyl compounds can be produced by causing the dehydration condensation of diols such as ethylene glycol, 1,4-butanediol, neopentyl glycol, and 1,6-hexane diol, or aliphatic triols such as glycerin and trimethylolpropane, if necessary, and then causing the reaction of epichlorohydrin with hydroxyl groups at terminals, according to any of the heretofore known methods.

The glycidyl ethers of polytetramethylene ether glycol can be represented by the following formula (1):

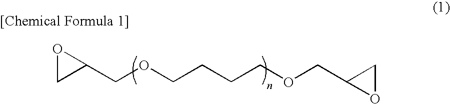

wherein n is an integer of from 1 to 30. The number average molecular weight of polytetramethylene ether glycol may preferably be in a range of from 200 to 2,000, more preferably from 250 to 1,500, and still more preferably from 500 to 1,000. Such a diglycidyl ether of polytetramethylene ether glycol can be obtained by any of the heretofore known production methods. More specifically, they can be obtained by a two-step method in which polytetramethylene ether glycol preferably having a number average molecular weight in a range of from 200 to 2,000, more preferably from 250 to 1,500, and still more preferably from 500 to 1,000, is reacted with epichlorohydrin in the presence of an acidic catalyst such as sulfuric acid, boron trifluoride ethyl ether, or tin tetrafluoride, or in the presence of a phase-transfer catalyst such as a quaternary ammonium salt, a quaternary phosphonium salt, or a crown ether, to obtain a chlorohydrin ether intermediate, and then, the chlorohydrin ether intermediate is reacted with a dehydrohalogenation agent such as sodium hydroxide to cause the ring closure thereof. In this case, if the number average molecular weight of polytetramethylene ether glycol is lower than 200, the flexibility of an epoxy film may be lowered. On the other hand, if the number average molecular weight of polytetramethylene ether glycol is higher than 2,000, the diglycidyl ether of polytetramethylene ether glycol becomes in a solid state and may be difficult to handle. The number average molecular weight of polytetramethylene ether glycol can be determined in terms of standard polystyrene conversion based on measurement by a gel permeation chromatography (GPC) method.

The diglycidyl ether of polytetramethylene ether glycol may be synthesized by the above production method but any of the commercially available products thereof may also be utilized. Examples of the commercially available products thereof may include jER (registered trade name) YL7217 and YL7410 available from Japan Epoxy Resin Co., Ltd.

The amount of polyglycidyl compound having a polyalkylene glycol chain(s) and at least two glycidyl groups to be contained may preferably be in a range of from 1 to 95 parts by mass, more preferably from 2 to 90 parts by mass, and still more preferably from 5 to 85 parts by mass, relative to 100 parts by mass of an epoxy resin composition. In this case, if the amount of polyglycidyl compound having a polyalkylene glycol chain(s) and at least two glycidyl groups to be contained is smaller than 1 part by mass, the flexibility of an epoxy film obtained from an epoxy resin composition may be lowered. On the other hand, if the amount of polyglycidyl compound having a polyalkylene glycol chain(s) and at least two glycidyl groups to be contained is greater than 95 parts by mass, there may be problems on the refractive index and strength of an epoxy film obtained from an epoxy resin composition.

(Bisphenol Type Epoxy Resin)

In order to adjust the refractive index of an epoxy film, a bisphenol type epoxy resin may preferably be contained in an epoxy resin composition.

Examples of the bisphenol type epoxy resin may include bisphenol A type epoxy resins, diglycidyl ethers of bisphenol A—alkylene oxide adducts, bisphenol F type epoxy resins, diglycidyl ethers of bisphenol F—alkylene oxide adducts, bisphenol AD type epoxy resins, bisphenol S type epoxy resins, tetramethyl bisphenol A type epoxy resins, tetramethyl bisphenol F type epoxy resins, and halogenated bisphenol type epoxy resins thereof (e.g., fluorinated bisphenol type epoxy resins, chlorinated bisphenol type epoxy resins, brominated bisphenol type epoxy resins). These bisphenol type epoxy resins may be used alone, or two or more of these bisphenol type epoxy resins may also be used in combination. In these bisphenol type epoxy resins, bisphenol A type epoxy resins, bisphenol F type epoxy resins, brominated bisphenol A type epoxy resins, and brominated bisphenol F type epoxy resins may be preferred in terms of their easy availability and handling property.

The amount of bisphenol type epoxy resin to be contained may appropriately be adjusted so as to make an epoxy film obtained from an epoxy resin composition have a desired refractive index, and therefore, it is not particularly limited; however, it may preferably be in a range of from 10 to 90 parts by mass, more preferably from 15 to 85 parts by mass, and still more preferably from 20 to 80 parts by mass, relative to 100 parts by mass of an epoxy resin composition. In this case, if the amount of bisphenol type epoxy resin to be contained is smaller than 10 parts by mass, it may become difficult to adjust the refractive index of an epoxy film obtained from an epoxy resin composition to be a high value or curing is extremely delayed so that it may be difficult to obtain an epoxy film. On the other hand, if the amount of bisphenol type epoxy resin to be contained is greater than 90 parts by mass, the flexibility of an epoxy film obtained from an epoxy resin composition may be lowered.

(Alicyclic Epoxy Resin)

In order to adjust the hardness of an epoxy film, an alicyclic epoxy resin may be contained, if necessary, in an epoxy resin composition.

Examples of the alicyclic epoxy resin may include 3,4-epoxycyclohexylmethyl-3′,4′-epoxycyclohexane carboxylate, ε-caprolactone-modified 3,4-epoxycyclohexylmethyl-3′,4′-epoxycyclohexane carboxylate, 1,2-epoxy-vinylcyclohexene, bis(3,4-epoxycyclohexylmethyl)adipate, 1-epoxyethyl-3,4-epoxycyclohexane, limonene diepoxide, 3,4-epoxycyclohexylmethanol, dicyclopentadiene diepoxide, epoxy resins obtained by the oxidation of olefins, such as oligomer type alicyclic epoxy resin (product name: Epoleed (registered trade name) GT300, Epoleed (registered trade name) GT400, EHPE-3150; available from Daicel Chemical Industries, Ltd.); epoxy resins obtained by the direct hydrogenation of aromatic epoxy resins, such as hydrogenated bisphenol A type epoxy resins, hydrogenated bisphenol F type epoxy resins, hydrogenated bisphenol type epoxy resins, hydrogenated phenol novolak type epoxy resins, hydrogenated cresol novolak type epoxy resins, and hydrogenated naphthalene type epoxy resins; epoxy resins obtained by the hydrogenation of polyhydric phenols, followed by the reaction with epichlorohydrin. These alicyclic epoxy resins may be used alone, or two or more of these alicyclic epoxy resins may also be used in combination. In these alicyclic epoxy resins, 3,4-epoxycyclohexylmethyl-3′,4′-epoxycyclohexane carboxylate, ε-caprolactone-modified 3,4-epoxycyclohexylmethyl-3′,4′-epoxycyclohexane carboxylate, hydrogenated bisphenol A type epoxy resins, and hydrogenated bisphenol F type epoxy resins may be preferred in terms of their easy availability, low viscosity, excellent workability, flexibility, and adhesiveness to a base material.

The amount of alicyclic epoxy resin to be contained may appropriately be adjusted so as to make an epoxy film obtained from an epoxy resin composition have desired hardness, and therefore, it is not particularly limited; however, it may preferably be in a range of from 10 to 90 parts by mass, more preferably from 15 to 85 parts by mass, and still more preferably from 20 to 80 parts by mass, relative to 100 parts by mass of an epoxy resin composition. In this case, if the amount of alicyclic epoxy resin to be maxed is smaller than 10 parts by mass, it may become difficult to adjust the refractive index of an epoxy film obtained from an epoxy resin composition to be a low value or curing is extremely delayed so that it may be difficult to obtain an epoxy film. On the other hand, if the amount of alicyclic epoxy resin to be contained is higher than 90 parts by mass, an epoxy film obtained from an epoxy resin composition may become hard and brittle.

The epoxy resin composition can be adjusted so as to have a viscosity in a range of from 10 to 100,000 mPa·s at a temperature of 23° C. without using any solvent by, for example, appropriately selecting the molecular weight of a polyglycidyl compound having a polyalkylene glycol chain(s) and at least two glycidyl groups as a raw material as well as the molecular weight(s) of a bisphenol type epoxy resin and/or an alicyclic epoxy resin to be contained, if necessary.

(Amine Type Curing Agent)

In order to cure an epoxy resin composition to form an epoxy film, for example, an amine type curing agent may be contained in the epoxy resin composition.

Examples of the amine type curing agent may include aliphatic diamines having one aromatic ring, such as o-xylylenediamine, m-xylylenediamine, and p-xylylenediamine; aliphatic diamines having one or two alicyclic structures, such as isophoronediamine, 1,3-bis(aminomethyl)cyclohexane, 1,4-bis(aminomethyl)cyclohexane, 1,2-cyclohexyldiamine, 1,3-cyclohexyldiamine, 1,4-cyclohexyldiamine, norbornanediamine, bis(aminomethyl)tricyclodacane, 4,4′-methylenebis(cyclohexylamine), 4,4′-methylenebis(2-methylcyclohexylamine), and 4,4′-methylenebis(2-ethyl-6-methylcyclohexylamine); and modified diamines obtained by the reaction of m-xylylenediamine, isophoronediamine, 1,3-bis(aminomethyl)cyclohexane, or 4,4′-methylenebis(cyclohexylamine) with phenols (formaldehyde), (meth)acrylates, monoepoxy compounds, styrene compounds, or acrylonitrile. These amine type curing agents may be used alone, or two or more of these amine type curing agents may also be used in combination. In these amine type curing agents, m-xylylenediamine, isophoronediamine, 1,3-bis(aminomethyl)cyclohexane, and modified products thereof may be preferred because they are excellent in reactivity with epoxy resins.

The amount of amine type curing agent to be contained in an epoxy resin composition may preferably be in a range of from 10 to 150 parts by mass, more preferably from 20 to 120 parts by mass, and still more preferably from 30 to 100 parts by mass, relative to 100 parts by mass of a total of a polyglycidyl compound having a polyalkylene glycol chain(s) and at least two glycidyl groups as well as a bisphenol type epoxy resin and/or an alicyclic epoxy resin to be contained, if necessary.

(Cation Polymerization Initiator)

In order to cure an epoxy resin composition to form an epoxy film, for example, a cationic polymerization initiator may be contained in the epoxy resin composition.

As the cationic polymerization initiator, there can be used at least one photo-cationic polymerization initiator which produces cationic species or Lewis acids by ultraviolet rays and/or at least one thermal cationic polymerization initiator which produces cationic species or Lewis acids by heat.

Examples of the photo-cationic polymerization initiator may include metal-fluoroboron complex salts and boron trifluoride complex compounds as described in U.S. Pat. No. 3,379,653; bis(perfluoroalkylsulfonyl)methane metal salts as described in U.S. Pat. No. 3,586,616; aryl diazonium compounds as described in U.S. Pat. No. 3,708,296; aromatic onium salts of group VIa elements as described in U.S. Pat. No. 4,058,400; aromatic onium salts of group Va elements as described in U.S. Pat. No. 4,069,055; dicarbonyl chelates of from group IIIa to Va elements as described in U.S. Pat. No. 4,068,091; thiopyrylium salts as described in U.S. Pat. No. 4,139,655; group VIb elements in form of MF₆⁻ anions (wherein M is selected from phosphorus, antimony, and arsenic) as described in U.S. Pat. No. 4,161,478; arylsulfonium complex salts as described in U.S. Pat. No. 4,231,951; aromatic iodonium complex salts and aromatic sulfonium complex salts as described in U.S. Pat. No. 4,256,828; bis[4-(diphenylsulfonio)phenyl]sulfide-bis-hexafluorometal salts (e.g., phosphates, arsenates, antimonates) as described by W. R. Watt et al. in the Journal of Polymer Science, Polymer Chemistry, vol. 22, p. 1789 (1984); mixed ligand metal salts of iron compounds; and silanol-aluminum complexes. These ultraviolet polymerization initiators may be used alone, or two or more of these ultraviolet polymerization initiators may also be used in combination. In these ultraviolet polymerization initiators, arylsulfonium complexes, aromatic iodonium complexes or aromatic sulfonium complexes of halogen-containing complex ions, and aromatic onium salts of group II, V, and VI elements may be preferred. Some of these salts are obtained as commercially available products such as UVI-6976 and UVI-6922 (available from The Dow Chemical Company); FX-512 (available from 3M Company); UVR-6990 and UVR-6974 (available from Union Carbide Corporation); UVE-1014 and UVE-1016 (available from General Electric Company); KI-85 (available from Degussa Aktiengesellschaft), SP-150 and SP-170 (available from by ADEKA Corporation); and San-Aid (registered trade name) SI-60L, SI-80L, SI-100L, SI-110L, and SI-180L (available from Sanshin Chemical Industry Co., Ltd.).

Examples of the thermal polymerization initiator may include cationic type or protonic acid catalysts such as triflates (i.e., trifluoromethanesulfonates), boron trifluoride ether complexes, and boron trifluoride. These thermal polymerization initiators may be used alone, or two or more of these thermal polymerization initiators may also be used in combination. In these thermal polymerization initiators, triflates may be preferred. Specific examples of the triflates may include diethylammonium triflate available as FC-520 from 3M Company, triethylammonium triflate, diisopropylammonium triflate, and ethyldiisopropylammonium triflate (many of them are described by R. R. Alm in Modern Coatings issued on October 1980). Some of the aromatic onium salts to be used as the photo-cationic polymerization initiator produce cation species by heat. These photo-cationic polymerization initiators can also be used as the thermal cationic polymerization initiator. Specific examples of such photo-cationic polymerization initiators may include San-Aid (registered trade name) SI-60L, SI-80L, SI-100L, SI-110L, and SI-180L (available from Sanshin Chemical Industry Co., Ltd.).

In these photo-cationic and thermal cationic polymerization initiators, onium salts may be preferred, and diazonium salts, iodonium salts, sulfonium salts, and phosphonium salts may particularly be preferred because they are excellent in handling property and balance between the latent property and the curability.

The amount of cationic polymerization initiator to be contained in an epoxy resin composition may preferably be in a range of from 0.1 to 10 parts by mass, more preferably from 0.5 to 8 parts by mass, and still more preferably from 1 to 5 parts by mass, relative to 100 parts by mass of a total of a polyglycidyl compound having a polyalkylene glycol chain(s) and at least two glycidyl groups as well as a bisphenol type epoxy resin and/or an alicyclic epoxy resin to be contained, if necessary.

<Epoxy Film>

An epoxy film constituting at least one of a lower cladding layer, a core layer, and an upper cladding layer is obtained by coating an appropriate amount of epoxy resin composition (in a liquid state at normal temperature) as described above on a base material, followed by thermally curing the epoxy resin composition at a temperature of from 20° C. to 150° C. for from 0.5 to 24 hours in the case where an amine type curing agent is contained in the epoxy resin composition, or followed by curing the epoxy resin composition through irradiation of ultraviolet rays having an integrated illumination intensity of from 0.01 to 10 J/cm² in the case where a photo-cationic polymerization initiator is contained in the epoxy resin composition, or followed by curing the epoxy resin composition through heating at a temperature of from 50° C. to 250° C. for from 0.5 to 24 hours in the case where a thermal cationic polymerization initiator is contained in the epoxy resin composition.

The refractive indexes of a lower cladding layer and an upper cladding layer are not particularly limited so long as they are lower than that of a core layer, and the refractive index of the core layer is not particularly limited so long as it is higher than those of the lower cladding layer and the upper cladding layer; however, the refractive index of an epoxy film constituting at least one of the lower cladding layer, the core layer, and the upper cladding layer can arbitrarily be adjusted in a range of from 1.45 to 1.65 according to the mixing ratio of a polyglycidyl compound having a polyalkylene glycol chain(s) and at least two glycidyl groups as well as a bisphenol type epoxy resin and/or an alicyclic epoxy resin to be contained, if necessary. The refractive index as used herein means a refractive index at a wavelength of 830 nm, which is obtained by measurement at a temperature of 23° C. using a prism coupler (e.g., product name: SPA-4000, available from by SAIRON TECHNOLOGY, INC.).

The thickness of an epoxy film(s) constituting a lower cladding layer and/or an upper cladding layer may appropriately be selected according to the applications of a flexible optical waveguide and other factors, and therefore, it is not particularly limited; however, it may preferably be in a range of from 5 to 1,000 μm, more preferably from 10 to 500 μm, and still more preferably from 20 to 100 μm. If the thickness of an epoxy film(s) constituting a lower cladding layer and/or an upper cladding layer is smaller than 5 μm, the strength of a flexible optical waveguide may be lowered. On the other hand, if the thickness of an epoxy film(s) constituting a lower cladding layer and/or an upper cladding layer is greater than 1,000 μm, the flexibility of a flexible optical waveguide may be lowered.

The thickness and width of an epoxy film constituting a core layer may appropriately be selected according to the wavelength of light to be used and other factors, and therefore, it is not particularly limited so long as the core layer is embedded in an upper cladding layer; however, it may preferably be in a range of from 5 to 1,000 μm, more preferably from 10 to 500 μm, and still more preferably from 20 to 100 μm. If the thickness and width of an epoxy film constituting a core layer are smaller than 5 μm, the amount of light to be transmitted in the core layer may be lowered. On the other hand, if the thickness and width of an epoxy film constituting a core layer is greater than 1,000 μm, the flexibility of a flexible optical waveguide may be lowered.

The use of an epoxy resin composition as described above makes it possible to obtain an epoxy film which is excellent in flexibility and durable to bending.

<Substrate>

In the case where the flexible optical waveguide of the present invention comprises a substrate, a polyimide film constituting the substrate is not particularly limited so long as it has flexibility, and in the case where an opto-electronic hybrid integrated flexible module is produced from a flexible optical waveguide, a polyimide film constituting a substrate is not particularly limited so long as it further has heat resistance (in particular, heat resistance assuming soldering; specifically, heat resistance to temperatures of from 200° C. to 250° C.), and any of the heretofore known polyimide films can be used.

A polyimide film can be obtained from a polyamide acid composition for substrates, comprising a polyamide acid obtained by the reaction of a diamine compound and a tetracarboxylic acid in an organic solvent. The polyamide acid composition for substrates may contain a fluorine-containing alkoxysilane, if necessary.

Examples of the diamine compound may include p-phenylenediamine, 4,4′-diaminodiphenyl ether, 3,4′-diaminodiphenyl ether, 4,4′-diaminodiphenylmethane, 2,2′-dimethyl-4,4′-diaminobiphenyl, 2,2-bis[4-(4-aminophenoxy)phenyl]propane, 1,4-bis(4-aminophenoxy)benzene, 9,9-bis(4-aminophenyl)fluorene, 5-chloro-1,3-diamino-2,4,6-trifluorobenzene, 2,4,5,6-tetrachloro-1,3-diaminobenzene, 2,4,5,6-tetrafluoro-1,3-diaminobenzene, 4,5,6-trichloro-1,3-diamino-2-fluorobenzene, 5-bromo-1,3-diamino-2,4,6-trifluorobenzene, and 2,4,5,6-tetrabromo-1,3-diaminobenzene. These diamine compounds may be used alone, or two or more of these diamine compounds may also be used in combination. In these diamine compounds, p-phenylenediamine, 4,4′-diaminodiphenyl ether, 3,4′-diaminodiphenyl ether, 4,4′-diaminodiphenylmethane, 2,4,5,6-tetrachloro-1,3-diaminobenzene, and 5-chloro-1,3-diamino-2,4,6-trifluorobenzene may be preferred.

Examples of the tetracarboxylic acid may include tetracarboxylic acids such as pyromellitic acid, 3,3′,4,4′-biphenyltetracarboxylic acid, 3,3′,4,4′-biphenyl ether tetracarboxylic acid, 3,3′,4,4′-benzophenonetetracarboxylic acid, 1,4-bis(3,4-dicarboxyphenoxy)benzene, bis(3,4-dicarboxyphenyl)sulfide, hexafluoro-3,3′,4,4′-biphenyltetracarboxylic acid, hexachloro-3,3′,4,4′-biphenyltetracarboxylic acid, hexafluoro-3,3′,4,4′-biphenyl ether tetracarboxylic acid, hexachloro-3,3′,4,4′-biphenyl ether tetracarboxylic acid, bis(3,4-dicarboxytrifluorophenyl)sulfide, bis(3,4-dicarboxytrichlorophenyl)sulfide, 1,4-bis(3,4-dicarboxytrifluorophenoxy)tetrafluorobenzene, 1,4-bis(3,4-dicarboxytrichlorophenoxy)tetrafluorobenzene, 1,4-bis(3,4-dicarboxytrifluorophenoxy)tetrachlorobenzene, 1,4-bis(3,4-dicarboxytrichlorophenoxy)tetrachlorobenzene, 3,6-difluoropyromellitic acid, 3,6-dichloropyromellitic acid, and 3-chloro-6-fluoropyromellitic acid; their corresponding didehydrides; their corresponding acid chlorides; and their corresponding esterified compounds, e.g., methyl esters and ethyl esters. These tetracarboxylic acids may be used alone, or two or more of these tetracarboxylic acids may also be used in combination. In these tetracarboxylic acids, pyromellitic acid, 3,3′,4,4′-biphenyltetracarboxylic acid, 3,3′,4,4′-biphenyl ether tetracarboxylic acid, 3,3′,4,4′-benzophenonetetracarboxylic acid, hexafluoro-3,3′,4,4′-biphenyltetracarboxylic acid, hexafluoro-3,3′,4,4′-biphenyl ether tetracarboxylic acid, 1,4-bis(3,4-dicarboxytrifluorophenoxy)tetrafluorobenzene, 1,4-bis(3,4-dicarboxytrifluorophenoxy)tetrachlorobenzene; their corresponding didehydrides; and their corresponding acid chlorides may be preferred.

The amount of diamine compound to be added is not particularly limited so long as it is an amount of which diamine compound can cause the efficient reaction with a tetracarboxylic acid. Specifically, the amount of diamine compound to be added is equimolar to that of a tetracarboxylic acid in terms of the stoichiometry of the reaction; however, it may preferably be from 0.8 to 1.2 moles, more preferably from 0.9 to 1.1 moles, in the case where the total mole number of tetracarboxylic acid is set to be 1 mole. In this case, if the amount of diamine compound to be added is smaller than 0.8 moles, the tetracarboxylic acid may remain in large amounts, and therefore, a refining step may become complicated and the degree of polymerization may not become high. On the other hand, if the amount of diamine compound to be added is greater than 1.2 moles, the diamine compound may remain in large amounts, and therefore, a refining step may become complicated and the degree of polymerization may not become high.

The reaction can be carried out in an organic solvent. The organic solvent is not particularly limited so long as it can promote the efficient reaction of a diamine compound with a tetracarboxylic acid and it is inactive to these raw materials. Examples of the organic solvent which can be used may include polar organic solvents such as N-methyl-2-pyrrolidone, N,N-dimethylacetamide, N,N-dimethylformamide, dimethyl sulfoxide, sulfolane, methyl isobutyl ketone, acetonitrile, and benzonitrile. These organic solvents may be used alone, or two or more of these organic solvents may also be used in combination. The amount of organic solvent is not particularly limited so long as it is an amount of which organic solvent can promote the efficient reaction of a diamine compound with a tetracarboxylic acid; however, it may preferably be such an amount that the concentration of diamine compound in an organic solvent may become from 1% to 80% by mass, more preferably from 5% to 50% by mass.

The reaction conditions of a diamine compound with a tetracarboxylic acid are not particularly limited so long as they are reaction conditions under which the reaction of these compounds can sufficiently be promoted. For example, the reaction temperature may preferably be from 0° C. to 100° C., more preferably from 20° C. to 50° C. Further, the reaction time may usually be from 1 to 144 hours, preferably from 2 to 120 hours. Further, the reaction may be carried out under any of increased pressures, normal pressures, or reduced pressures; however, the reaction may preferably be carried out under normal pressures. Further, the reaction of a diamine compound with a tetracarboxylic acid may preferably be carried out under a dry inert gas atmosphere in view of the reaction efficiency and the degree of polymerization. The relative humidity in the reaction atmosphere at that time may preferably be 10% RH or lower, more preferably 1% RH or lower. As the inert gas, for example, nitrogen, helium, and argon can be used.

Because a polyamide acid composition for substrates is in a liquid state at normal temperature, a polyimide film constituting a substrate can be obtained by coating an appropriate amount of composition on a base material, followed by treatment such as heat treatment or reduced pressure drying, to cause the ring closure of a polyamide acid in the composition.

The methods and conditions for carrying out treatment such as heat treatment or reduced pressure drying are not particularly limited so long as they are methods and conditions such that a polyamide acid in the composition can cause the efficient ring closure thereof to produce a desired polyimide film. Specifically, the heat treatment may usually be carried out in air, preferably in an atmosphere of an inert gas such as nitrogen, helium, or argon at a temperature of preferably from about 70° C. to about 350° C. for preferably from about 2 to about 5 hours. The heat treatment may be carried out in a continuous or stepwise manner. Further, the reduced pressure drying may usually be carried out at normal temperature, or under cooling or heating, in a reduced pressure of preferably from about 1.33×10⁻¹ Pa (i.e., 1×10⁻³ Torr) to less than about 1.01×10⁵ Pa (i.e., 760 Torr) for preferably from about 2 to about 24 hours. The reduced pressure drying may be carried out in a continuous or stepwise manner.

In order to lower the specific permittivity of a polyimide film constituting a substrate, a fluorine-containing alkoxysilane may be contained, if necessary, in a polyamide acid composition for substrates.

Specific examples of the fluorine-containing alkoxysilane may include (3,3,3-trifluoropropyl)trimethoxysilane, (1H,1H,2H,2H-perfluorooctyl)trimethoxysilane, fluorotriethoxysilane, (1H,1H,2H,2H-perfluorooctyl)triethoxysilane, (1H,1H,2H,2H-perfluorodecyl)triethoxysilane, {3-(heptafluoroisopropoxy)propyl}triethoxysilane, (3,3,3-trifluoropropyl)methyldimethoxysilane, and (1H,1H,2H,2H-perfluorooctyl)methyldimethoxysilane. These fluorine-containing alkoxysilanes may be used alone, or two or more of these fluorine-containing alkoxysilanes may also be used in combination. In these fluorine-containing alkoxysilanes, (3,3,3-trifluoropropyl)methyldimethoxysilane may be preferred.

The amount of fluorine-containing alkoxysilane to be contained may be in a range of from 1% to 90% by mass, preferably from 5% to 80% by mass, and more preferably from 10% to 70% by mass, relative to a polyamide acid in the composition. If the amount of fluorine-containing alkoxysilane to be contained is smaller than 1% by mass, the specific permittivity of a polyimide film to be obtained cannot sufficiently be lowered. On the other hand, if the amount of fluorine-containing alkoxysilane to be contained is greater than 90% by mass, a polyimide film to be obtained may become deteriorated in appearance.

The thickness of a polyimide film constituting a substrate may appropriately be selected according to the applications of a flexible optical waveguide, the wavelength of light to be used, and other factors, and therefore, it is not particularly limited; however, it may preferably be in a range of from 5 to 100 μm, more preferably from 10 to 50 μm. If the thickness of a polyimide film constituting a substrate is smaller than 5 μm, the strength of the substrate may be lowered. On the other hand, if the thickness of a polyimide film constituting a substrate is greater than 100 μm, the flexibility of the substrate may be lowered, and in the case where an opto-electronic hybrid integrated flexible module is produced from a flexible optical waveguide, the transparency of the substrate may be lowered.

The refractive index of a polyimide film constituting a substrate is not particularly limited; however, it can be adjusted by allowing, for example, a metal oxide precursor, a catalyst for reaction to produce a metal oxide from the precursor, and/or a coupling agent having a reactive group to be contained, in addition to a polyamide acid (or a halogenated polyamide acid), in a polyamide acid composition for substrates.

Examples of the metal oxide precursor may include alkoxysilanes such as tetramethoxysilane, tetraethoxysilane, tetrapropoxysilane, tetraisopropoxysilane, tetrabutoxysilane, trimethoxymethylsilane, triethoxymethylsilane, tributoxymethylsilane, and tetraphenoxysilane, and their condensates; alkoxytitanium compounds such as tetramethoxytitanium, tetraethoxytitanium, tetraisopropoxytitanium, and tetra-n-butoxytitanium; and alkoxyzirconium compounds such as tetramethoxyzirconium, tetraethoxyzirconium, tetra-n-propoxyzirconium, and tetra-n-butylzirconium. These metal oxide precursors may be used alone, or two or more of these metal oxide precursors may also be used in combination. In these metal oxide precursors, tetramethoxysilane and its condensates may be preferred.

The amount of metal oxide precursor to be contained may preferably be from 5% to 60% by mass, more preferably from 10% to 50% by mass, and still more preferably from 15% to 40% by mass, relative to a polyamide acid (or a halogenated polyamide acid) in the composition. If the amount of metal oxide precursor to be contained is smaller than 5% by mass, the refractive index of a polyimide film may not sufficiently be controlled. On the other hand, if the amount of metal oxide precursor to be contained is greater than 60% by mass, a polyimide film may become deteriorated in appearance.

As the metal oxide precursor, metal chelate compounds can also be used. Examples of the metal chelate compounds are titanium tetraacetylacetonate, zirconium tetraacetylacetonate, zirconium tributoxyacetylacetonate, zirconium dibutoxybis(acetylacetonate), and zirconium butoxyacetylacetonate (ethylacetonate). These metal chelate compounds may be used alone, or two or more of these metal chelate compounds may also be used in combination.

The catalyst is not particularly limited so long as it has a function of promoting the reaction to produce a metal oxide from a metal oxide precursor. Examples of the catalyst may include acids such as hydrochloric acid, acetic acid, and oxalic acid; bases such as ammonia and organic amines; as well as trimethoxyborane and trimethyl phosphite. These catalysts may be used alone, or two or more of these catalysts may also be used in combination. In these catalysts, trimethoxyborane may be preferred.

In the case where a catalyst is contained in the composition, the amount of catalyst to be contained may preferably be from 0.02% to 15% by mass, more preferably from 0.1% to 10% by mass, and still more preferably from 0.2% to 5% by mass, relative to a polyamide acid (or a halogenated polyamide acid) in the composition. If the amount of catalyst to be contained is smaller than 0.02% by mass, a metal oxide may not sufficiently be produced from a metal oxide precursor. On the other hand, if the amount of catalyst to be contained is greater than 15% by mass, the function of the catalyst may be saturated, and at the same time, the catalyst may be used beyond necessity and production costs may be increased.

Examples of the coupling agent having a reactive group may include amino group-containing silane coupling agents such as γ-aminopropyltrimethoxysilane and γ-aminopropyltriethoxysilane; aminoalkylamino group-containing silane coupling agents such as γ-(2-aminoethyl)aminopropyltrimethoxysilane, γ-(2-aminoethyl)aminopropyltriethoxysilane, γ-(3-aminopropyl)aminopropyltrimethoxysilane, and γ-(3-aminopropyl)aminopropyltriethoxysilane; glycidoxy group-containing silane coupling agents such as γ-glycidoxypropyltrimethoxysilane, γ-glycidoxypropylmethyldimethoxysilane, and γ-glycidoxypropyltriethoxysilane; isocyanate group-containing silane coupling agents such as γ-isocyanatepropyltrimethoxysilane; vinyl group-containing silane coupling agents such as vinyltrimethoxysilane and vinyltriethoxysilane; acryloxy group-containing silane coupling agents such as γ-acryloxypropyltrimethoxysilane; methacryl group-containing silane coupling agents such as γ-methacryloxypropyltrimethoxysilane, γ-methacryloxypropylmethyldimethoxysilane, γ-methacryloxypropyltriethoxysilane, and γ-methacryloxypropylmethyldiethoxysilane; mercapto group-containing silane coupling agents such as γ-mercaptopropyltrimethoxysilane and γ-mercaptopropylmethyldimethoxysilane; halogen group-containing silane coupling agents such as γ-chloropropyltrimethoxysilane; amino group-containing titanate type coupling agents such as isopropyltri(5-aminopentyl)titanate, isopropyltri(6-aminohexyl)titanate, isopropyltri(7-aminoheptyl)titanate, and isopropyltri(8-aminooctyl)titanate; and aminoalkylamino group-containing titanate type coupling agents such as isopropyltri(2-aminoethyl-aminoethyl)titanate, isopropyltri(2-aminoethyl-aminopropyl)titanate, isopropyltri(3-aminopropyl-aminoethyl)titanate, and isopropyltri(3-aminopropyl-aminopropyl)titanate. These coupling agents may be used alone, or two or more of these coupling agents may also be used in combination. In these coupling agents, silane coupling agents may be preferred and amino group-containing silane coupling agents such as γ-aminopropyltrimethoxysilane and γ-aminopropyltriethoxysilane may particularly be preferred.

In the case where a coupling agent is contained in the composition, the amount of coupling agent to be contained may preferably be from 1% to 20% by mass, more preferably from 1.5% to 18% by mass, and still more preferably from 2% to 15% by mass, relative to a polyamide acid (or a halogenated polyamide acid) in the composition. If the amount of coupling agent to be contained is smaller than 1% by mass, a polyimide and a metal oxide may cause phase separation after treatment such as heat treatment or reduced pressure drying to lower the appearance, transparency, and surface smoothness of a polyimide film. On the other hand, if the amount of coupling agent to be contained is greater than 20% by mass, gelation may occur at the time of preparing a polyamide acid composition.

If a polyamide acid composition for substrates as described above is used, a polyimide film to be obtained becomes excellent in flexibility and heat resistance, and therefore, it sufficiently exhibits excellent performance as the substrate of a flexible optical waveguide. Further, because a polyimide film constituting a substrate is excellent in heat resistance, an opto-electronic hybrid integrated flexible module can be produced from a flexible optical waveguide.

<Lower Cladding Layer>

In the flexible optical waveguide of the present invention, a resin film constituting a lower cladding layer is not particularly limited so long as it has flexibility as well as adhesiveness to a polyimide film constituting a substrate in the case where the flexible optical waveguide has the substrate, adhesiveness to a resin film constituting a core layer, and adhesiveness to a resin film constituting an upper cladding layer. As the resin film constituting a lower cladding layer, there can be used films composed of any of the heretofore known materials for optical waveguides, such as epoxy resins, polyimide resins, acrylic resins, cycloolefin resins, polyether sulfone resins, polyether ketone resins, polyether nitrile resins, silane type resins, and silicone resins. In these resin films, from the viewpoint of adhesiveness, films composed of epoxy resins, that is, epoxy films may be preferred; epoxy films formed using epoxy resin compositions each containing a polyglycidyl compound having a polyalkylene glycol chain(s) and at least two glycidyl groups may be more preferred; and epoxy films formed using epoxy resin compositions each containing a diglycidyl ether of polytertramethylene ether glycol may be still more preferred. Further, from the viewpoint of heat resistance, films composed of polyimide resins, that is, polyimide films (including halogenated polyimide films) may be preferred. In the polyimide films similar to a polyimide film constituting a substrate in the case where a flexible optical waveguide has the substrate, from the further viewpoint of prevention of water absorption, halogenated polyimide films may be preferred; and fluorinated polyimide films may be more preferred.

In the case where a lower cladding layer is composed of, for example, an epoxy film, this epoxy film is formed using an epoxy resin composition for lower cladding layers. The epoxy resin composition for lower cladding layers may be prepared in a manner similar to that of an epoxy resin composition as described above. The epoxy resin composition for lower cladding layers can be adjusted so as to have a viscosity in a range of from 10 to 100,000 mPa·s at a temperature of 23° C. without using any solvent by, for example, appropriately selecting the molecular weight of a polyglycidyl compound having a polyalkylene glycol chain(s) and at least two glycidyl groups as a raw material as well as the molecular weight(s) of a bisphenol type epoxy resin and/or an alicyclic epoxy resin to be contained, if necessary. Further, an epoxy film constituting a lower cladding layer is formed by coating an epoxy resin composition for lower cladding layers on a base material or a substrate, followed by curing the composition. In addition, the formation conditions of an epoxy film constituting a lower cladding layer are the same as those of epoxy films as described above.

In the case where a lower cladding layer is composed of, for example, a polyimide film, this polyimide film is formed using a polyamide acid resin composition for lower cladding layers. The polyamide acid resin composition for lower cladding layers may preferably be prepared in a manner similar to that of the polyamide acid resin composition for substrates. Further, a polyimide film constituting a lower cladding layer is formed by coating a polyamide acid resin composition for lower cladding layers on a base material or a substrate, followed by curing the composition. In addition, the formation conditions of a polyimide film constituting a lower cladding layer are the same as those of a polyimide film constituting a substrate.

The thickness of a resin film constituting a lower cladding layer may appropriately be selected according to the applications of a flexible optical waveguide, the wavelength of light to be used, and other factors, and therefore, it is not particularly limited; however, specifically, it may preferably be in a range of from 5 to 1,000 μm, more preferably from 10 to 500 μm, and still more preferably from 20 to 100 μm. If the thickness of a resin film constituting a lower cladding layer is smaller than 5 μm, the strength of a flexible optical waveguide may be lowered. On the other hand, if the thickness of a resin film constituting a lower cladding layer is greater than 1,000 μm, the flexibility of a flexible optical waveguide may be lowered.

An epoxy film constituting a lower cladding later may have, in the case where a flexible optical waveguide has a substrate, a multilayer structure consisting of two or more layers to satisfy both of adhesiveness of the lower cladding layer to the substrate and strength of the optical waveguide film. For example, in order to form a lower cladding layer with a two-layer structure, a first layer containing no alicyclic epoxy resin may be formed on a substrate and a second layer containing an alicyclic epoxy resin may be formed on the first layer.

The refractive index of a resin film constituting a lower cladding layer is not particularly limited so long as it is lower than the refractive index of a resin film constituting a core layer; however, it can arbitrarily be adjusted in a range of from 1.45 to 1.65 according to, for example, the composition of an epoxy resin composition for lower cladding layers (e.g., the mixing ratio of a polyglycidyl compound having a polyalkylene glycol chain(s) and at least two glycidyl groups as well as a bisphenol type epoxy resin and/or an alicyclic epoxy resin to be contained, if necessary) or the composition of a polyamide acid composition for lower cladding layers (e.g., the types of diamine compound and tetracarboxylic acid to be used at the time of preparing a polyamide acid, and the type and number of halogen atom in the case where a polyamide acid contains a halogen atom(s), and also, the type and mixing amount of metal oxide precursor in the case where a metal oxide precursor is contained in the polyamide acid composition for lower cladding layers). The refractive index as used herein means a refractive index at a wavelength of 830 nm, which is obtained by measurement at a temperature of 23° C. using a prism coupler (e.g., product name: SPA-4000, available from SAIRON TECHNOLOGY, INC.).

If a preferable epoxy resin composition for lower cladding layers as described above is used, an epoxy film to be obtained is excellent in adhesiveness to resin films constituting a core layer and an upper cladding layer, and therefore, as the resin films constituting the core layer and the upper cladding layer, there can be used resin films heretofore known as those for optical waveguides. Further, if an epoxy resin composition as described above is used as the epoxy resin composition for lower cladding layers, an epoxy film to be obtained is excellent in flexibility and durable to bending, and in the case where an optical waveguide has a substrate, is excellent in adhesiveness to a polyimide film constituting the substrate, and therefore, in contrast to prior art techniques, there is no need to attach an optical waveguide film to the substrate with an adhesive and a lower cladding layer can be formed by being directly adhered onto the substrate.

<Core Layer>

In the flexible optical waveguide of the present invention, a resin film constituting a core layer is not particularly limited so long as it has low waveguide loss and at the same time is excellent in patterning property. As the resin film constituting the core layer, there can be used films composed of any of the heretofore known materials for optical waveguides, such as epoxy resins, polyimide resins, acrylic resins, cycloolefin resins, polyether sulfone resins, polyether ketone resins, polyether nitrile resins, silane type resins, and silicone resins. In these resin films, from the viewpoint of adhesiveness, films composed of epoxy resins, that is, epoxy films may be preferred; epoxy films formed using epoxy resin compositions each containing a polyglycidyl compound having a polyalkylene glycol chain(s) and at least two glycidyl groups may be more preferred; and epoxy films formed using epoxy resin compositions each containing a diglycidyl ether of polytertramethylene ether glycol may be still more preferred. Further, from the viewpoint of heat resistance, films composed of polyimide resins, that is, polyimide films (including halogenated polyimide films) may be preferred. In the polyimide films similar to polyimide films constituting substrates in the case where a flexible optical waveguide has a substrate, halogenated polyimide films may be preferred; and partially fluorinated polyimide films may be more preferred.

In the case where a core layer is composed of, for example, an epoxy film, this epoxy film is formed using an epoxy resin composition for core layers. The epoxy resin composition for core layers may preferably be prepared in the same manner as that of an epoxy resin composition for lower cladding layers, except that the composition (e.g., the types and mixing amounts of ingredients to be contained) is changed to adjust the refractive index of an epoxy film to be obtained. The epoxy resin composition for core layers can be adjusted so as to have a viscosity in a range of from 10 to 100,000 mPa·s at a temperature of 23° C. without using any solvent by, for example, appropriately selecting the molecular weight of a polyglycidyl compound having a polyalkylene glycol chain(s) and at least two glycidyl groups as a raw material as well as the molecular weight(s) of a bisphenol type epoxy resin and/or an alicyclic epoxy resin to be contained, if necessary. Further, an epoxy film constituting a core layer is formed by coating an epoxy resin composition for core layers on a lower cladding layer, followed by curing the composition while placing a mask thereon, and then removing uncured portions. In addition, the formation conditions of an epoxy film constituting a core layer are the same as those of epoxy films as described above.

In the case where a core layer is composed of, for example, a polyimide film, this polyimide film is formed using a polyamide acid resin composition for core layers. The polyamide acid resin composition for core layers may preferably be prepared in the same manner as that of a polyamide acid resin composition for substrates, except that the composition (e.g., the types and mixing amounts of ingredients to be contained) is changed to adjust the refractive index of a polyimide film to be obtained. Further, a polyimide film constituting a core layer may preferably be formed by coating a polyamide acid resin composition for core layers on a lower cladding layer, followed by curing the composition, and then forming a patterned resist layer thereon and removing uncoated portions. In addition, the formation conditions of a polyimide film constituting a core layer are the same as those of a polyimide film constituting a substrate.

The thickness and width of a resin film constituting a core layer may appropriately be selected according to the applications of a flexible optical waveguide, the wavelength of light to be used, and other factors, and therefore, they are not particularly limited; however, they may preferably be in a range of from 5 to 1,000 μm, more preferably from 10 to 500 μm, and still more preferably from 20 to 100 μm. If the thickness and width of a resin film constituting a core layer are smaller than 5 μm, the amount of light to be transmitted in the core layer may be lowered. On the other hand, if the thickness of a resin film constituting a core layer is greater than 1,000 μm, the flexibility of a flexible optical waveguide may be lowered.

The refractive index of a resin film consisting a core layer is not particularly limited so long as it is higher than the refractive indexes of resin films constituting a lower cladding layer and an upper cladding layer; however, it can arbitrarily be adjusted in a range of from 1.45 to 1.65 according to the composition of an epoxy resin composition for core layers (e.g., the mixing ratio of a polyglycidyl compound having a polyalkylene glycol chain(s) and at least two glycidyl groups as well as a bisphenol type epoxy resin and/or an alicyclic epoxy resin to be contained, if necessary) or the composition of a polyamide acid composition for core layers (e.g., the types of diamine compound and tetracarboxylic acid to be used at the time of preparing a polyamide acid, the type and number of halogen atom in the case where a polyamide acid contains a halogen atom(s), and also, the type and mixing amount of metal oxide precursor in the case where a metal oxide precursor is contained in the polyamide acid composition for core layers). The refractive index as used herein means a refractive index at a wavelength of 830 nm, which is obtained by measurement at a temperature of 23° C. using a prism coupler (e.g., product name: SPA-4000, available from SAIRON TECHNOLOGY, INC.).

In addition, the number of core layer to be embedded in the upper cladding layer may appropriately be set according to the applications of a flexible optical waveguide and other factors, and therefore, it is not particularly limited; however, it may be one layer or more. Further, the core layer may be formed into a prescribed pattern according to the applications of a flexible optical waveguide and other factors.

<Upper Cladding Layer>

In the flexible optical waveguide of the present invention, a resin film constituting an upper cladding layer is not particularly limited so long as it has flexibility as well as adhesiveness to a resin film constituting a lower cladding layer and adhesiveness to a resin film constituting a core layer. As the resin film constituting the upper cladding layer, there can be used films composed of any of the heretofore known materials for optical waveguides, such as epoxy resins, polyimide resins, acrylic resins, cycloolefin resins, polyether sulfone resins, polyether ketone resins, polyether nitrile resins, silane type resins, and silicone resins. In these resin films, from the viewpoint of adhesiveness, films composed of epoxy resins, that is, epoxy films may be preferred; epoxy films formed using epoxy resin compositions each containing a polyglycidyl compound having a polyalkylene glycol chain(s) and at least two glycidyl groups may be more preferred; and epoxy films formed using epoxy resin compositions each containing diglycidyl ethers of polytertramethylene ether glycol may be still more preferred. Further, from the viewpoint of heat resistance, films composed of polyimide resins, that is, polyimide films (including halogenated polyimide films) may be preferred. In the polyimide films similar to a polyimide film constituting a substrate in the case where a flexible optical waveguide has the substrate, from the further viewpoint of prevention of water absorption, halogenated polyimide films may be preferred; and fluorinated polyimide films may be more preferred.

In the case where an upper cladding layer is composed of, for example, an epoxy film, this epoxy film is formed using an epoxy resin composition for upper cladding layers. The epoxy resin composition for upper cladding layers may preferably be prepared in a manner similar to that of an epoxy resin composition for lower cladding layers. The epoxy resin composition for upper cladding layers can be adjusted so as to have a viscosity in a range of from 10 to 100,000 mPa·s at a temperature of 23° C. without using any solvent by, for example, appropriately selecting the molecular weight of a polyglycidyl compound having a polyalkylene glycol chain(s) and at least two glycidyl groups as a raw material as well as the molecular weight(s) of a bisphenol type epoxy resin and/or an alicyclic epoxy resin to be contained, if necessary. Further, an epoxy film constituting an upper cladding layer is formed by coating an epoxy resin composition for upper cladding layers on a lower cladding layer while including a core layer, followed by curing the composition. In addition, the formation conditions of an epoxy film constituting an upper cladding layer are the same as those of epoxy films as described above.

In the case where an upper cladding layer is composed of, for example, a polyimide film, this polyimide film is formed using a polyamide acid resin composition for upper cladding layers. The polyamide acid resin composition for upper cladding layers may preferably be prepared in a manner similar to the polyamide acid resin composition for substrates. Further, a polyimide film constituting an upper cladding layer is formed by coating a polyamide acid resin composition for upper cladding layers on a lower cladding layer while including a core layer, followed by curing the composition. In addition, the formation conditions of a polyimide film constituting an upper cladding layer are the same as those of a polyimide film constituting a substrate.

The thickness of a resin film constituting an upper cladding layer may appropriately be selected according to the applications of a flexible optical waveguide, the wavelength of light to be used, and other factors, and therefore, it is not particularly limited; however, it may preferably be in a range of from 5 to 1,000 μm, more preferably from 10 to 500 μm, and still more preferably from 20 to 100 μm. If the thickness of a resin film constituting an upper cladding layer is smaller than 5 μm, it may become impossible to form a core layer having a sufficient thickness. On the other hand, if the thickness of a resin film constituting an upper cladding layer is greater than 1,000 μm, the flexibility of a flexible optical waveguide may be lowered.

The refractive index of a resin film consisting an upper cladding layer is not particularly limited so long as it is lower than the refractive index of a resin film constituting a core layer; however, it can arbitrarily adjusted in a range of from 1.45 to 1.65 according to the composition of an epoxy resin composition for upper cladding layers (e.g., the mixing ratio of a polyglycidyl compound having a polyalkylene glycol chain(s) and at least two glycidyl groups as well as a bisphenol type epoxy resin and/or an alicyclic epoxy resin to be contained, if necessary) or the composition of a polyamide acid composition for upper cladding layers (e.g., the types of diamine compound and tetracarboxylic acid to be used at the time of preparing a polyamide acid, the type and number of halogen atom in the case where a polyamide acid contains a halogen atom(s), and also, the type and mixing amount of metal oxide precursor in the case where a metal oxide precursor is contained in the polyamide acid composition for upper cladding layers). The refractive index as used herein means a refractive index at a wavelength of 830 nm, which is obtained by measurement at a temperature of 23° C. using a prism coupler (e.g., product name: SPA-4000, available from SAIRON TECHNOLOGY, INC.).

If an epoxy resin composition for upper cladding layers as described above is used as an epoxy resin composition for upper cladding layers, an epoxy film to be obtained is excellent in adhesiveness to resin films constituting a lower cladding layer and a core layer, and therefore, as the resin films constituting a lower cladding layer and a core layer, there can be used resin films heretofore known for use in optical waveguides. Further, if an epoxy resin composition as described above is used as an epoxy resin composition for upper cladding layers, an epoxy film to be obtained is excellent, in flexibility and durable to bending.

<<Applications of Flexible Optical Waveguide>>

The flexible optical waveguide of the present invention can be used, similarly to ordinary optical waveguides, for various optical waveguide apparatuses. The optical waveguide apparatuses as used herein mean apparatuses including optical waveguides, examples of which may include optical multiplexers/demultiplexers, splitters, photoelectric transducers, wavelength filters, and AWG. The flexible optical waveguide of the present invention is excellent in flexibility and durable to bending, and it can be bent at 180 degrees with a radius of 1 mm. When waveguide loss is measured in a state that the flexible optical waveguide of the present invention is bent at 90 degrees with a radius of 10 mm or bent at 180 degrees with a radius of 1 mm and then turned back to the prior state, the waveguide loss value is not changed from that measured before bending, and therefore, optical waveguide apparatuses each containing the flexible optical waveguide of the present invention can be made compact. Further, the flexible optical waveguide of the present invention can also be used for optical interconnections.

The flexible optical waveguide of the present invention is, in the case where an optical waveguide film is formed on a substrate composed of a polyimide film, excellent in adhesiveness between the substrate and the optical waveguide film and exhibits high resistance to moisture and heat, even after it is allowed to stand still for a long time under high temperature and high humidity environments, and therefore, there can be obtained optical waveguide apparatuses usable under severe environments. Further, with respect to the flexible optical waveguide of the present invention, because a polyimide film constituting a substrate is excellent in heat resistance, opto-electronic hybrid integrated flexible modules can be produced. Such opto-electronic hybrid integrated flexible modules can preferably be used for parts (e.g., hinge parts) required to be flexible in electronic equipments such as mobile phones, digital cameras, digital video cameras, domestic and portable game machines, notebook type personal computers, and high speed printers, by taking advantage of the characteristic feature that the flexible optical waveguide of the present invention is durable to bending.

<<Process for Producing Flexible Optical Waveguide>>

A process for producing a flexible optical waveguide according to the present invention comprises steps of forming a lower cladding layer, forming a core layer on the lower cladding layer, and forming an upper cladding layer on the lower cladding layer and the core layer in a manner of embedding the core layer therein, wherein at least one of the lower cladding layer, the core layer, and the upper cladding layer is formed using an epoxy resin composition containing a polyglycidyl compound having a polyalkylene glycol chain(s) and at least two glycidyl groups.

In this production method, the lower cladding layer is formed using a resin composition for lower cladding layers, the core layer is formed using a resin composition for core layers, and the upper cladding layer is formed using a resin composition for upper cladding layers. At least one of the resin composition for lower cladding layers, the resin composition for core layers, and the resin composition for upper cladding layers is an epoxy resin composition containing a polyglycidyl compound having a polyalkylene glycol chain(s) and at least two glycidyl groups. In the case the resin composition for lower cladding layers and/or the resin composition for core layers and/or the resin composition for upper cladding layers contain a solvent(s), it is required to carry out a step of drying a coated film after forming the coated film from the resin composition containing the solvent(s).

Methods of forming a substrate, a lower cladding layer, a core layer, and an upper cladding layer may be employed from the heretofore known methods, and therefore, they are not particularly limited.

In the case of a substrate, there can be mentioned, a method of coating a polyamide acid composition on a base material by any of the heretofore known coating techniques such as spin coating technique, bar coater technique, roll coater technique, gravure coater technique, and knife coater technique, followed by curing the composition.

In the case of a lower cladding layer, a method of coating a resin composition for lower cladding layers on a base material or substrate by any of the heretofore known coating techniques such as spin coating technique, bar coater technique, roll coater technique, gravure coater technique, and knife coater technique, followed by curing the composition.

In the case of a core layer, a method of coating a resin composition for core layers on a lower cladding layer by any of the heretofore known coating techniques such as spin coating technique, bar coater technique, roll coater technique, gravure coater technique, and knife coater technique, followed by curing the composition.

In the case of an upper cladding layer, a method of coating a resin composition for upper cladding layers on a lower cladding layer, including a core layer, by any of the heretofore known coating techniques such as spin coating technique, bar coater technique, roll coater technique, gravure coater technique, and knife coater technique, followed by curing the composition.

Additionally, in the case of a core layer, it is required that a resin composition for core layers is coated on a lower cladding layer, followed by curing the composition while placing a mask thereon, and then removing uncured portions, or alternatively, a resin composition for core layers is coated on a lower cladding layer, followed by curing the composition, then forming a patterned resist layer thereon, and removing uncoated portions. Further, as methods of forming a core layer, besides the above methods, there can also be used methods such as relief printing, engraved printing, mold forming methods, dispenser methods, and inkjet methods. Further, without using a base material, production may be started from an epoxy film or any other resin film constituting a lower cladding layer, and then a core layer and an upper cladding layer may successively be formed thereon, or production may be started from a polyimide film constituting a substrate, and then a lower cladding layer, a core layer, and an upper cladding layer may successively be formed thereon.

Alternatively, as disclosed in Japanese Patent Laid-open Publication (Kokai) Nos. 2007-139898 and 2007-139900, the following method may be employed: that is, a method comprising dicing a base material to produce a concave mold having a groove(s) on the surface thereof, producing a convex mold made of a silicone material or a nickel-plated material using the concave mold, forming a lower cladding layer having a core groove(s) using this convex mold, filling a resin composition for core layers in the core groove(s) by a micro dispenser, followed by curing, to form the core layer, and forming an upper cladding layer on the lower cladding layer in which the core layer is embedded. In addition, a concave mold may be produced by any of the heretofore known methods, and there may be mentioned, for example, a method of forming a concave mold by photolithography using a resist made of a photosensitive resin or the like and a photo-mask having a desired optical waveguide pattern, and a method of cutting a metal in a desired optical waveguide pattern using a tool for metal processing. Alternatively, after a convex mold is produced, a concave mold is produced from the convex mold, and using the concave mold, a core layer having a desired core pattern may be formed on a lower cladding layer.

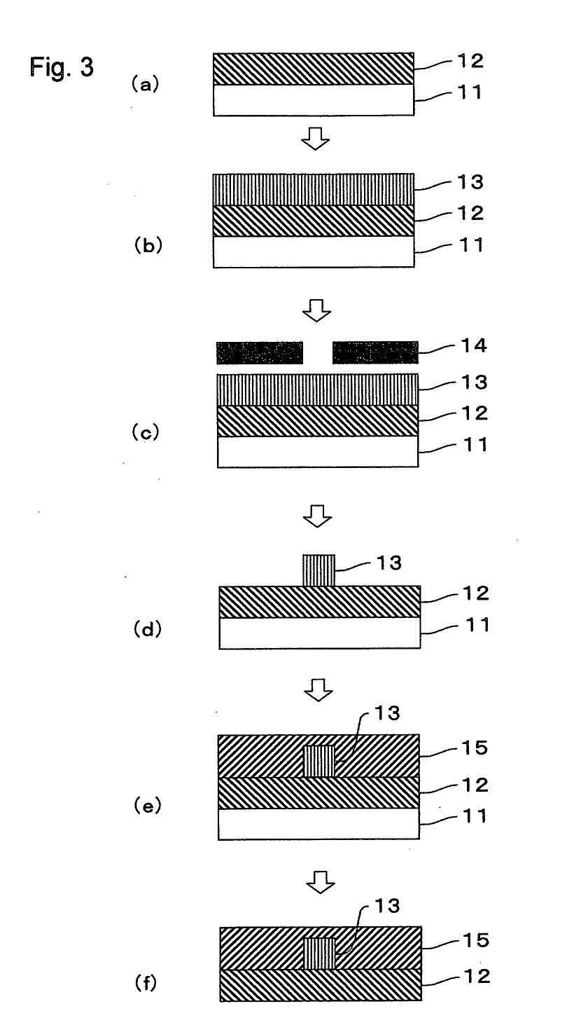

Referring to FIG. 3, a typical example of the process for producing a flexible optical waveguide shown in FIG. 1 will be described below in detail; however, the production process of the present invention is not limited to the following typical example and may be carried out with appropriate modifications or variations. FIG. 3 shows the case where a lower cladding layer is composed of a photo-cured or heat-cured resin film, a core layer is composed of a photo-cured resin film, and an upper cladding layer is composed of a photo-cured or heat-cured resin film. In FIG. 3, reference numerals 12, 13, and 15 have the same meanings as those in FIG. 1, and reference numeral 11 is a base material, and reference numeral 14 is a photo-mask. In FIG. 3(f), although only one core layer 13 is formed, two or more core layers may be formed according to the applications of a flexible optical waveguide and other factors. Further, although the core layer 13 is formed in the form of a line extending along the vertical direction to the paper of the drawing, it may be formed into a prescribed pattern according to the applications of a flexible optical waveguide and other factors.

First, as shown in FIG. 3(a), a photo-curable or heat-curable resin composition for lower cladding layers is dropped on a base material 11 such as a silicon substrate or quartz glass to form a film by spin coating technique or any other coating technique, and this coated film is subjected to treatment such as ultraviolet irradiation or heat treatment to form a lower cladding layer 12 composed of a photo-cured or heat-cured resin film. Further, as shown in FIG. 3(b), a photo-curable resin composition for core layers is dropped on the lower cladding layer 12 to form a film by spin coating technique or any other coating technique, and as shown in FIG. 3(c), a photo-mask 14 is put on the core layer 13, followed by carrying out ultraviolet irradiation, and uncured portions are washed away with an appropriate solvent to form a patterned core layer 13 as shown in FIG. 3(d). Then, as shown in FIG. 3(e), a photo-curable or heat-curable resin composition for upper cladding layers is dropped on the core layer 13 and the portions of the lower cladding layer 12, which portions are not covered with the core layer 13, to form a film by spin coating technique or any other coating technique, and this coated film is subjected to treatment such as ultraviolet irradiation or heat treatment to form an upper cladding layer 15 composed of a photo-cured or heat-cured resin film. Finally, an optical waveguide film is separated from the base material 11 to obtain a flexible optical waveguide in which the lower cladding layer 12, the core layer 13, and the upper cladding layer 15 are composed of the photo-cured or heat-cured resin films as shown in FIG. 3(f). At least one of the lower cladding layer 12, the core layer 13, and the upper cladding layer 15 is composed of an epoxy film formed using an epoxy resin composition containing a polyglycidyl compound having a polyalkylene glycol chain(s) and at least two glycidyl groups.

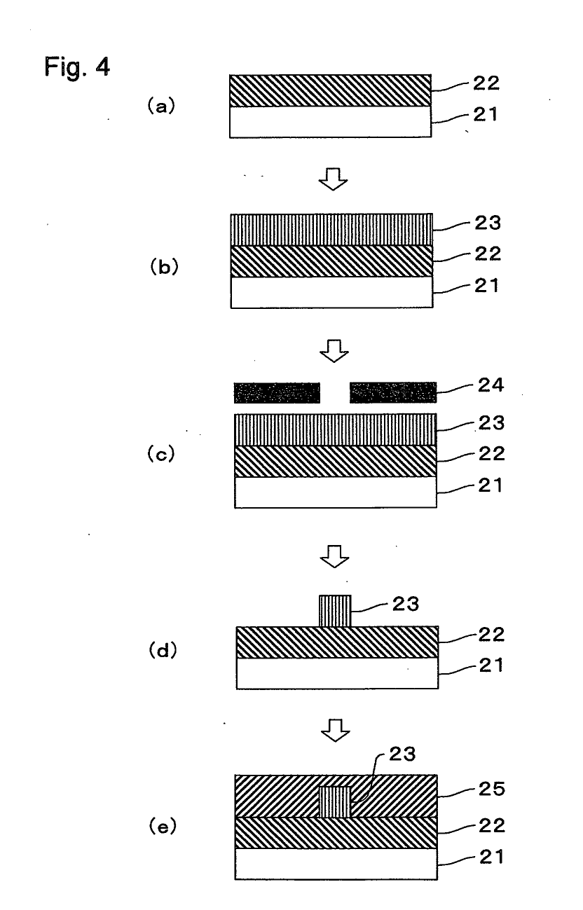

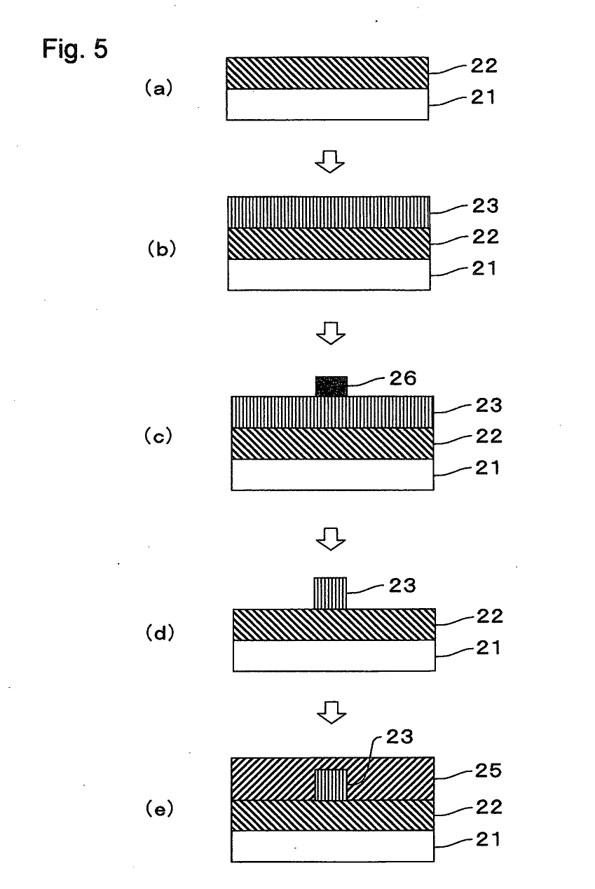

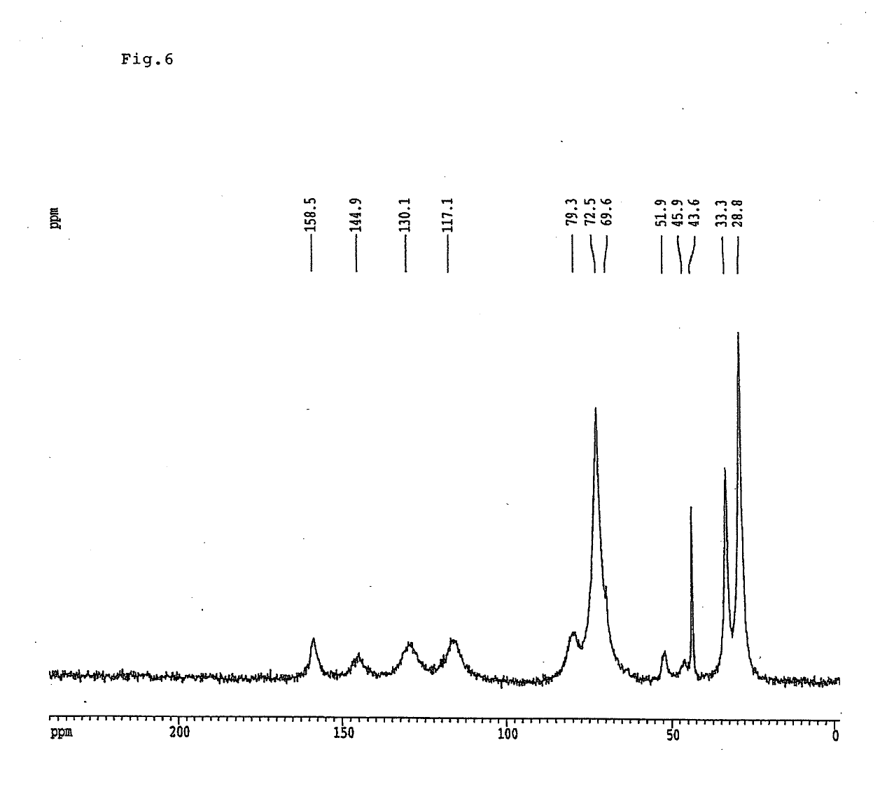

Referring to FIGS. 4 and 5, a typical example of the process for producing a flexible optical waveguide shown in FIG. 2 will be described below in detail; however, the production process of the present invention is not limited to the following typical example and may be carried out with appropriate modifications or variations. FIG. 4 shows the case where a substrate is composed of a polyimide film, a lower cladding layer is composed of a photo-cured or heat-cured resin film, a core layer is composed of a photo-cured resin film, and an upper cladding layer is composed of a photo-cured or heat-cured resin film. FIG. 5 shows the case where a substrate is composed of a polyimide film, a lower cladding layer is composed of a photo-cured or heat-cured resin film, a core layer is composed of a heat-cured resin film, and an upper cladding layer is composed of a photo-cured or heat-cured resin film. In FIGS. 4 and 5, reference numerals 21 to 23 and 25 have the same meaning as those in FIG. 2, and reference numeral 24 is a photo-mask, and reference numeral 26 is a resist layer. In FIGS. 4(e) and 5(e), although only one core layer 23 is formed, two or more layers may be formed according to the applications of a flexible optical waveguide and other factors. Further, although the core layer 23 is formed in the form of a line extending along the vertical direction to the paper of the drawing, it may be formed into a prescribed pattern according to the applications of a flexible optical waveguide and other factors.

First, a polyamide acid composition for substrates is dropped on a base material (not shown) such as a silicon substrate or quartz glass to form a film by spin coating technique or any other coating technique, and this coated film is subjected to treatment such as heat treatment or reduced pressure drying treatment to form a substrate 21 composed of a polyimide film. Then, as shown in FIG. 2(a), a photo-curable or heat-curable resin composition for lower cladding layers is dropped on the substrate 21 to form a film by spin coating technique or any other coating technique, and this coated film is subjected to treatment such as ultraviolet irradiation or heat treatment to form a lower cladding layer 22 composed of a photo-cured or heat-cured resin film. Further, as shown in FIG. 4(b), a photo-curable resin composition for core layers is dropped on the lower cladding layer 22 to form a film by spin coating technique or any other coating technique, and as shown in FIG. 4(c), a photo-mask 24 is put on the core layer 23, followed by carrying out ultraviolet irradiation, and uncured portions are washed away with an appropriate solvent to form a patterned core layer 23 as shown in FIG. 4(d). Then, as shown in FIG. 4(e), a photo-curable or heat-curable resin composition for upper cladding layers is dropped on the core layer 23 and the portions of the lower cladding layer 22, which portions are not covered with the core layer 23, to form a film by spin coating technique or any other coating technique, and this coated film is subjected to treatment such as ultraviolet irradiation or heat treatment to form an upper cladding layer 25 composed of a photo-cured or heat-cured resin film. Finally, an optical waveguide film including the substrate 21 is separated from the base material (not shown) to obtain a flexible optical waveguide in which the substrate 21 is composed of the polyimide film, and the lower cladding layer 22, the core layer 23, and the upper cladding layer 25 are composed of the photo-cured or heat-cured resin films as shown in FIG. 4(e). At least one of the lower cladding layer 22, the core layer 23, and the upper cladding layer 25 is composed of an epoxy film formed using an epoxy resin composition containing a polyglycidyl compound having a polyalkylene glycol chain(s) and at least two glycidyl groups.

Alternatively, first, a polyamide acid composition for substrates is dropped on a base material (not shown) such as a silicon substrate or quartz glass to form a film by spin coating technique or any other coating technique, and this coated film is subjected to treatment such as heat treatment or reduced pressure drying treatment to form a substrate 21 composed of a polyimide film. Then, as shown in FIG. 5(a), a heat-curable or photo-curable resin composition for lower cladding layers is dropped on the substrate 21 to form a film by spin coating technique or any other coating technique, and this coated film is subjected to treatment such as ultraviolet irradiation or heat treatment to form a lower cladding layer 22 composed of a photo-cured or heat-cured resin film. Further, as shown in FIG. 5(b), a heat-curable resin composition for core layers is dropped on the lower cladding layer 22 to form a film by spin coating technique or any other coating technique. Further, as shown in FIG. 5(c), a photoresist is coated on the core layer 23, followed by pre-baking, exposing, developing, and after-baking, to form a patterned resist layer 26. Successively, as shown in FIG. 5(d), after the portions of the core layer 23, which portions are not covered with the resist layer 26, are removed by dry etching, the resist layer 26 is separated to form a patterned core layer 23 on the lower cladding layer 22. Then, as shown in FIG. 5(e), a photo-curable or heat-curable resin composition for upper cladding layers is dropped on the core layer 23 and the portions of the lower cladding layer 22, which portions are not covered with the core layer 23, to form a film by spin coating technique or any other coating technique, and this coated film is subjected to treatment such as ultraviolet irradiation or heat treatment to form an upper cladding layer 25 composed of a photo-cured or heat-cured resin film. Finally, an optical waveguide film including the substrate 21 is separated from the base material (not shown) to obtain a flexible optical waveguide in which the substrate 21 is composed of the polyimide film, and the lower cladding layer 22, the core layer 23, and the upper cladding layer 25 are composed of the photo-cured or heat-cured resin films as shown in FIG. 5(e). At least one of the lower cladding layer 22, the core layer 23, and the upper cladding layer 25 is composed of an epoxy film formed using an epoxy resin composition containing a polyglycidyl compound having a polyalkylene glycol chain(s) and at least two glycidyl groups.

The process for producing a flexible optical waveguide according to the present invention is not limited to sheet-fed processes for producing flexible optical waveguides one by one in the production method as described above, and the following continuous process to continuously obtain flexible optical waveguides may be employed: that is, the continuous process comprises previously producing a roll of a photo-cured or heat-cured resin film constituting a lower cladding layer from a photo-curable or heat-curable resin composition for lower cladding layers, and while drawing out the film from the roll, successively forming a core layer and an upper cladding layer on the photo-cured or heat-cured film constituting the lower cladding layer, or the continuous process comprises, in the case where each of the flexible optical waveguides has a substrate composed of a polyimide film, previously producing a roll of the polyimide film constituting the substrate using a polyamide acid composition for substrates, and while drawing out the film from the roll, successively forming a lower cladding layer, a core layer, and an upper cladding layer on the polyimide film constituting the substrate.

The process for producing a flexible optical waveguide according to the present invention employs, in the case where the flexible optical waveguide has no substrate, a method of producing a flexible optical waveguide film by successively forming a lower cladding layer, a core layer, and an upper cladding layer, without forming a film constituting the substrate. If such a method is employed, particularly, because there is no need for a step of forming a film constituting the substrate, flexible optical waveguides can easily be produced and production costs can remarkably be saved.

The process for producing a flexible optical waveguide according to the present invention usually employs, in the case where the flexible optical waveguide has a substrate, a method of producing a flexible optical waveguide film by successively forming a lower cladding layer, a core layer, and an upper cladding layer on the substrate to produce an optical waveguide film, without attaching a previously produced optical waveguide film to the substrate with an adhesive or vacuum laminating previously produced epoxy resin films on the substrate, followed by curing, as in the conventional techniques. If such a method is employed, particularly, because there is no need for a step of forming an adhesive layer between the substrate and the lower cladding layer, and in addition to this, because the lower cladding layer; the core layer, and the upper cladding layer are successively formed on the substrate, an optical waveguide film can be formed on the substrate in a simple and easy manner, and therefore, production costs can remarkably be saved.

<<Epoxy Resin Composition for Flexible Optical Waveguide>>

An epoxy resin composition for flexible optical waveguides according to the present invention comprises a polyglycidyl compound having a polyalkylene glycol chain(s) and at least two glycidyl groups, the composition having a refractive index after curing of from 1.45 to 1.65. As the polyglycidyl compound having a polyalkylene glycol chain(s) and at least two glycidyl groups, diglycidyl ethers of polytetramethylene ether glycol may particularly be preferred.

The refractive index after curing as used herein means the refractive index of an epoxy film obtained from this resin composition. Further, the refractive index as used herein means a refractive index at a wavelength of 830 nm, which is obtained by measurement at a temperature of 23° C. using a prism coupler (e.g., product name: SPA-4000, available from SAIRON TECHNOLOGY, INC.).

The epoxy resin composition for flexible optical waveguides according to the present invention may contain an amine type curing agent or a cationic polymerization initiator and if necessary, a bisphenol type epoxy resin and/or an alicyclic epoxy resin, in addition to the polyglycidyl compound having a polyalkylene glycol chain(s) and at least two glycidyl groups as an essential ingredient. Specific examples and mixing amounts of the polyglycidyl compound having a polyalkylene glycol chain(s) and at least two glycidyl groups, the bisphenol type epoxy resin, the alicyclic epoxy resin, the amine type curing agent, and the cationic polymerization initiator are as described above. The epoxy resin composition for flexible optical waveguides according to the present invention can contain a solvent(s). The solvent(s) is not particularly limited so long as it can dissolve an epoxy resin as described above.

The epoxy resin composition for flexible optical waveguides according to the present invention can be adjusted so as to have a viscosity in a range of from 10 to 100,000 mPa·s at a temperature of 23° C. without using any solvent by appropriately selecting the molecular weight of a polyglycidyl compound having a polyalkylene glycol chain(s) and at least two glycidyl groups as a raw material as well as the molecular weight(s) of a bisphenol type epoxy resin and/or an alicyclic epoxy resin to be contained, if necessary.

In order to produce an epoxy film(s) constituting a lower cladding layer and/or an upper cladding layer from the epoxy resin compositions for flexible optical waveguides according to the present invention, the mixing ratio of a polyglycidyl compound having a polyalkylene glycol chain(s) and at least two glycidyl groups as well as the mixing ratio(s) of a bisphenol type epoxy resin and/or an alicyclic epoxy resin to be contained, if necessary, may be adjusted in such a manner that the refractive index after curing becomes preferably at least 0.01 lower than, more preferably at least 0.03 lower than, and still more preferably at least 0.05 lower than, that of an epoxy film or any other resin film constituting a core layer, within a range of from 1.45 to 1.65.

Further, in order to produce an epoxy film constituting a core layer from the epoxy resin composition for flexible optical waveguides according to the present invention, the mixing ratio of a polyglycidyl compound having a polyalkylene glycol chain(s) and at least two glycidyl groups and the mixing ratio(s) of a bisphenol type epoxy resin and/or an alicyclic epoxy resin to be contained, if necessary, may be adjusted in such a manner that the refractive index after curing becomes preferably at least 0.01 higher than, more preferably at least 0.03 higher than, and still more preferably at least 0.05 higher than, that of an epoxy film(s) or any other resin film(s) constituting a lower cladding layer and/or an upper cladding layer, within a range of from 1.45 to 1.65.

The epoxy resin composition for flexible optical waveguides according to the present invention gives an epoxy film which is excellent in flexibility and durable to bending. Therefore, a flexible optical waveguide having a lower cladding layer and/or a core layer and/or an upper cladding layer, composed of such an epoxy film, is excellent in flexibility and durable to bending, and therefore, it can be bent at 180 degrees with a radius of 1 mm and when waveguide loss is measured in a state that the flexible optical waveguide is bent at 90 degrees with a radius of 10 mm or bent at 180 degrees with a radius of 1 mm and then turned back to the prior state, the waveguide loss value is not changed from that before being bent.

### EXAMPLES

The present invention will be described below in more detail by way of Examples, but the present invention is not limited to the following Examples. The present invention can be put into practice after appropriate modifications or variations within a range meeting the gists described above and later, all of which are included in the technical scope of the present invention.

First, the following will describe measurement methods of waveguide loss and wet heat resistance as evaluation methods of flexible optical waveguides produced in Examples and Comparative Examples.

<<Measurement of Waveguide Loss>>

Each of the flexible optical waveguides obtained was provided with a light input port and a light output port by cutting its end faces using a dicing saw (product name: DAD321, available from DISCO Corporation) so that the length of an optical waveguide became 5 cm. A quartz optical fiber having a core diameter of 50 μm was connected to a light emitting diode having a wavelength of 850 nm and the other fiber end was set to be an input fiber end. On the other hand, a quartz optical fiber having a core diameter of 50 μm was connected to a light power meter (product name: MT9810A, available from Anritsu Corporation) and the other fiber end was set to be an output fiber end. The input fiber end was allowed to come face to face with the output fiber end, and then, positioning was carried out in such a manner that the intensity of the light power meter (product name: MT9810A, available from Anritsu Corporation) became the maximum light intensity by an automatic fiber alignment apparatus (available from Suruga Seiki Co., Ltd.), and the light intensity at that time was set to be Ref (dBm). Successively, the input fiber end of one optical fiber and the output fiber end of the other optical fiber were allowed to come face to face with the respective end faces of the optical waveguide, and positioning of the respective optical fibers was carried out in such a manner that the intensity of the light power meter (product name: MT9810A, available from Anritsu Corporation) became the maximum light intensity by an automatic fiber alignment apparatus (available from Suruga Seiki Co., Ltd.), and the light intensity at that time was set to be OBS (dBm). The insertion loss INT (dB) of the 5 cm optical waveguide was calculated by the formula: Ref (dBm)−OBS (dBm). Successively, the optical waveguide was cut at 1 cm inner side from one of the end faces using a dicing saw (product name: DAD321, available from DISCO Corporation) to obtain an optical waveguide having a length of 4 cm and in the same manner as described above, the insertion loss INT (dB) of the 4 cm optical waveguide was calculated. In the same manner, the optical waveguide was cut one by one centimeter until the length of the optical waveguide became 1 cm, and the insertion loss INT (dB) calculation was repeated. The respective data were plotted while setting the length (cm) of the optical waveguide in the horizontal axis and the insertion loss INT (dB) in the vertical axis, and the waveguide loss (dB/cm) of the optical waveguide was obtained from the inclination of the resultant straight line. This method is referred to usually as a cut-back method.

<<Evaluation of Wet Eat Resistance>>

The optical waveguide film, including the substrate, of each of the resultant flexible optical waveguides was put in a constant temperature and humidity apparatus (product name: SH-221, available from Espec Corporation) and allowed to stand still under an environment at a temperature of 85° C. and at a relative humidity of 85% RH for 2,000 hours, followed by observation of its appearance.

Then, the following will describe preparations of epoxy resin compositions for cladding layers, epoxy resin compositions for core layers, polyamide acid compositions for substrates, and a polyamide acid composition for cladding layers, all of which are for producing flexible optical waveguides.

<<Preparation of Epoxy Resin Composition (1) for Cladding Layers>>

An epoxy resin composition (1) for cladding layers was prepared by mixing 41 parts by mass of a diglycidyl ether of polytetramethylene ether glycol (product name: jER (registered trade name) YL7217, available from Japan Epoxy Resins Co., Ltd.; the number average molecular weight thereof was from 700 to 800), 55 parts by mass of a bisphenol A type epoxy resin (product name: jER (registered trade name) 828EL, available from Japan Epoxy Resins Co., Ltd.), and 4 parts by mass of hexafluorophosphoric acid aryl sulfonium salt (product name: UVI-6992, available from The Dow Chemical Company) by the use of a rotation and revolution type centrifugal mixing apparatus (product name: AWATORI RENTARO (registered trade name), available from THINKY CORPORATION).

The viscosity of the epoxy resin composition (1) for cladding layers was measured at a temperature of 23° C. using a rheometer (product name: RC20-CPS, Rheotec Co., Ltd.) and found to be 540 mPa·s. Further, the refractive index of the epoxy resin composition (1) for cladding layers after curing obtained under the curing conditions which were the same as those of Example 1 described below was measured at a wavelength of 830 nm using a prism coupler (product name: SPA-4000, available from SAIRON TECHNOLOGY, INC.) and found to be 1.53. The glass transition temperature (Tg) of the epoxy resin composition (1) for cladding layers after curing was measured at a temperature increasing rate of 20° C./min under a nitrogen atmosphere using a differential scanning calorimeter (product name: DSC 220, available from Seiko Instruments Inc.) and found to be −2° C. The 5% weight decrease temperature of the epoxy resin composition (1) for cladding layers after curing was measured at a temperature increasing rate of 10° C./min under a nitrogen atmosphere using a TG/DTA simultaneous measurement apparatus (product name: DTG-50, available from Shimadzu Corporation) and found to be 333° C.

Further, the epoxy resin composition (1) for cladding layers after curing was pulverized and the resultant powder was filled in a zirconia test tube having a diameter of 4 mm. ¹³C-solid NMR measurement was carried out while spinning the test tube at 12,000 Hz. The measurement apparatus was a nuclear magnetic resonance apparatus (product name: AVANCE400, available from Bruker Biospin K.K.) and a 4 mm probe for solid measurement was used. The measurement condition was at a resonance frequency of 100.63 MHz by the CP/MAS (cross-polarization magic-angle spinning) method using a 90° pulse width of 4.5 μsec for a contact time of 2 msec. The chemical shift was measured while the carbonyl peak of glycine was set at 176.03 ppm as an external standard.

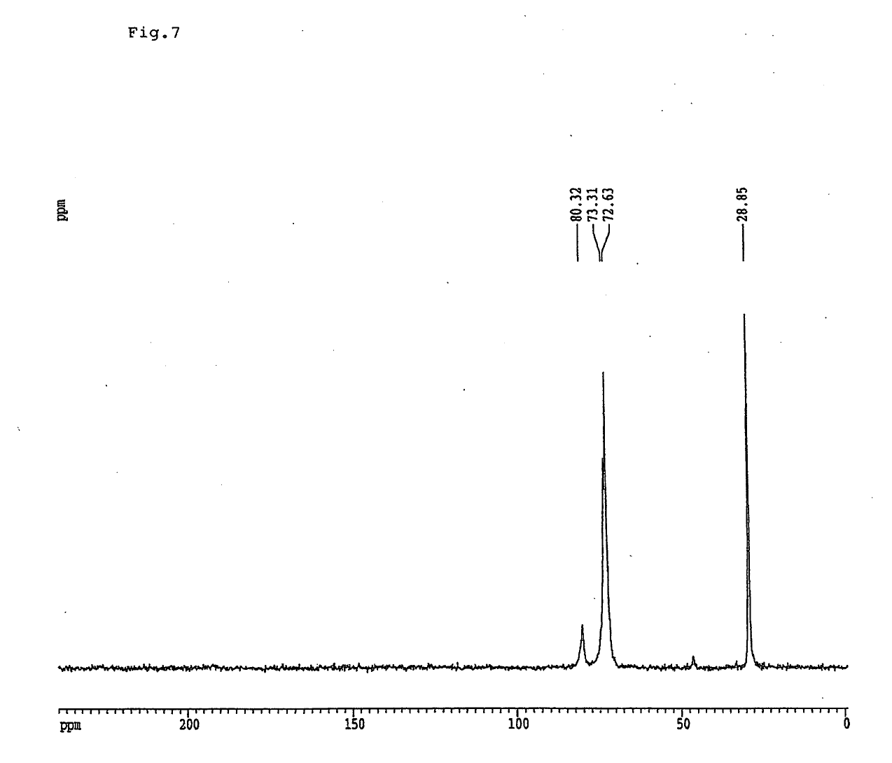

The ¹³C-solid NMR spectrum of the epoxy resin composition (1) for cladding layers after curing measured in a manner as described above is shown in FIG. 6. In FIG. 6, a characteristic peak at 28.8 ppm is derived from two carbon atoms on an inner side of the tetramethylene chain sandwiched between ether bonds. This fact is clear by comparison between the ¹³C-solid NMR spectrum shown in FIG. 6 and the ¹³C-solid NMR spectrum of a cured product of the diglycidyl ether of polytetramethylene ether glycol (product name: jER (registered trade name) YL7217, available from Japan Epoxy Resins Co., Ltd.; the number average molecular weight thereof was from 700 to 800) shown in FIG. 7.

As described above, if a cured product of an epoxy resin composition was analyzed using ¹³C-solid NMR measurement, the presence of polyalkylene glycol chain(s), e.g., polytetramethylene ether glycol chain(s), in the cured product can be confirmed.

<<Preparation of Epoxy Resin Composition (2) for Cladding Layers>>

An epoxy resin composition (2) for cladding layers was prepared by mixing 8 parts by mass of a diglycidyl ether of polytetramethylene ether glycol (product name: jER (registered trade name) YL7217, available from Japan Epoxy Resins Co., Ltd.; the number average molecular weight thereof was from 700 to 800), 55 parts by mass of a bisphenol A type epoxy resin (product name: jER (registered trade name) 828EL, available from Japan Epoxy Resins Co., Ltd.), 33 parts by mass of a hydrogenated bisphenol A type epoxy resin (product name: jER (registered trade name) YX8000, available from Japan Epoxy Resins Co., Ltd.), and 4 parts by mass of hexafluorophosphoric acid aryl sulfonium salt (product name: UVI-6992, available from The Dow Chemical Company) by the use of a rotation and revolution type centrifugal mixing apparatus (product name: AWATORI RENTARO (registered trade name), available from Thinky Corporation).

The viscosity of the epoxy resin composition (2) for cladding layers was measured at a temperature of 23° C. using a rheometer (product name: RC20-CPS, Rheotec Co., Ltd.) and found to be 3,000 mPa·s. Further, the refractive index of the epoxy resin composition (2) for cladding layers after curing obtained under the curing conditions which were the same as those of Example 1 described below was measured at a wavelength of 830 nm using a prism coupler (product name: SPA-4000, available from SAIRON TECHNOLOGY, INC.) and found to be 1.53. The glass transition temperature (Tg) of the epoxy resin composition (2) for cladding layers after curing was measured using a differential scanning calorimeter (product name: DSC 220, available from Seiko Instruments Inc.) at a temperature increasing rate of 20° C./min under a nitrogen atmosphere and found to be 75° C.

<<Preparation of Epoxy Resin Composition (3) for Cladding Layers>>

An epoxy resin composition (3) for cladding layers was prepared by mixing 64 parts by mass of a diglycidyl ether of polytetramethylene ether glycol (product name: jER (registered trade name) YL7217, available from Japan Epoxy Resins Co., Ltd.; the number average molecular weight thereof was from 700 to 800), 32 parts by mass of a bisphenol A type epoxy resin (product name: jER (registered trade name) 828EL, available from Japan Epoxy Resins Co., Ltd.), and 4 parts by mass of hexafluorophosphoric acid aryl sulfonium salt (product name: UVI-6992, available from The Dow Chemical Company) by the use of a rotation and revolution type centrifugal mixing apparatus (product name: AWATORI RENTARO (registered trade name), available from Thinky Corporation).

The viscosity of the epoxy resin composition (3) for cladding layers was measured at a temperature of 23° C. using a rheometer (product name: RC20-CPS, available from Rheotec Co., Ltd.) and found to be 180 mPa·s. Further, the refractive index of the epoxy resin composition (3) for cladding layers after curing obtained under the curing conditions which were the same as those of Example 1 described below was measured at a wavelength of 830 nm using a prism coupler (product name: SPA-4000, available from SAIRON TECHNOLOGY, INC.) and found to be 1.50. The glass transition temperature (Tg) of the epoxy resin composition (3) for cladding layers after curing was measured using a differential scanning calorimeter (product name: DSC 220, available from Seiko Instruments Inc.) at a temperature increasing rate of 20° C./min under a nitrogen atmosphere and found to be −21° C.

<<Preparation of Epoxy Resin Composition (4) for Cladding Layers>>

An epoxy resin composition (4) for cladding layers was prepared by mixing 38 parts by mass of a diglycidyl ether of polytetramethylene ether glycol (product name: jER (registered trade name) YL7217, available from Japan Epoxy Resins Co., Ltd.; the number average molecular weight thereof was from 700 to 800), 58 parts by mass of an alicyclic epoxy resin (product name: Celoxide (registered trade name) 2081, available from Daicel Chemical Industries, Ltd.), and 4 parts by mass of hexafluorophosphoric acid aryl sulfonium salt (product name: UVI-6992, available from The Dow Chemical Company) by the use of a rotation and revolution type centrifugal mixing apparatus (product name: AWATORI RENTARO (registered trade name), available from Thinky Corporation).

The viscosity of the epoxy resin composition (4) for cladding layers was measured at a temperature of 23° C. using a rheometer (product name: RC20-CPS, available from Rheotec Co., Ltd.) and found to be 110 mPa·s. Further, the refractive index of the epoxy resin composition (4) for cladding layers after curing obtained under the curing conditions which were the same as those of Example 1 described below was measured at a wavelength of 830 nm using a prism coupler (product name: SPA-4000, available from SAIRON TECHNOLOGY, INC.) and found to be 1.50. The glass transition temperature (Tg) of the epoxy resin composition (4) for cladding layers after curing was measured using a differential scanning calorimeter (product name: DSC 220, available from Seiko Instruments Inc.) at a temperature increasing rate of 20° C./min under a nitrogen atmosphere and found to be 13° C.

<<Preparation of Epoxy Resin Composition (1) for Core Layers>>

An epoxy resin composition (1) for core layers was prepared by mixing 9 parts by mass of a diglycidyl ether of polytetramethylene ether glycol (product name: jER (registered trade name) YL7217, available from Japan Epoxy Resins Co., Ltd.; the number average molecular weight thereof was from 700 to 800), 45 parts by mass of a bisphenol A type epoxy resin (product name: jER (registered trade name) 828EL, available from Japan Epoxy Resins Co., Ltd.), 45 parts by mass of a brominated bisphenol A type epoxy resin (product name: jER (registered trade name) 5050, available from Japan Epoxy Resins Co., Ltd.), and 1 part by mass of hexafluorophosphoric acid aryl sulfonium salt (product name: UVI-6992, available from The Dow Chemical Company) by the use of a rotation and revolution type centrifugal mixing apparatus (product name: AWATORI RENTARO (registered trade name), available from Thinky Corporation).

The viscosity of the epoxy resin composition (1) for core layers was measured at a temperature of 23° C. using a rheometer (product name: RC20-CPS, available from Rheotec Co., Ltd.) and found to be 83,680 mPa·s. Further, the refractive index of the epoxy resin composition (1) for core layers after curing obtained under the curing conditions which were the same as those of Example 1 described below was measured at a wavelength of 830 nm using a prism coupler (product name: SPA-4000, available from SAIRON TECHNOLOGY, INC.) and found to be 1.58. The glass transition temperature (Tg) of the epoxy resin composition (1) for core layers after curing was measured using a differential scanning calorimeter (product name: DSC 220, available from Seiko Instruments Inc.) at a temperature increasing rate of 20° C./min under a nitrogen atmosphere and found to be 49° C.

<<Preparation of Epoxy Resin Composition (2) for Core Layers>>

An epoxy resin composition (2) for core layers was prepared by mixing 28 parts by mass of a diglycidyl ether of polytetramethylene ether glycol (product name: jER (registered trade name) YL7217, available from Japan Epoxy Resins Co., Ltd.; the number average molecular weight thereof was from 700 to 800), 71 parts by mass of a bisphenol A type epoxy resin (product name: jER (registered trade name) 828EL, available from Japan Epoxy Resins Co., Ltd.), and 1 part by mass of hexafluorophosphoric acid aryl sulfonium salt (product name: UVI-6992, available from The Dow Chemical Company) by the use of a rotation and revolution type centrifugal mixing apparatus (product name: AWATORI RENTARO (registered trade name), available from Thinky Corporation).

The viscosity of the epoxy resin composition (2) for core layers was measured at a temperature of 23° C. using a rheometer (product name: RC20-CPS, available from Rheotec Co., Ltd.) and found to be 1,210 mPa·s. Further, the refractive index of the epoxy resin composition (1) for core layers after curing obtained under the curing conditions which were the same as those of Example 1 described below was measured at a wavelength of 830 nm using a prism coupler (product name: SPA-4000, available from SAIRON TECHNOLOGY, INC.) and found to be 1.55. The glass transition temperature (Tg) of the epoxy resin composition (2) for core layers after curing was measured using a differential scanning calorimeter (product name: DSC 220, available from Seiko Instruments Inc.) at a temperature increasing rate of 20° C./min under a nitrogen atmosphere and found to be 25° C.

<<Preparation of Epoxy Resin Composition (3) for Core Layers>>

An epoxy resin composition (3) for core layers was prepared by mixing 28 parts by mass of a diglycidyl ether of polytetramethylene ether glycol (product name: jER (registered trade name) YL7217, available from Japan Epoxy Resins Co., Ltd.; the number average molecular weight thereof was from 700 to 800), 71 parts by mass of a bisphenol A type epoxy resin (product name: jER (registered trade name) YL6810, available from Japan Epoxy Resins Co., Ltd.), and 1 part by mass of hexafluorophosphoric acid aryl sulfonium salt (product name: UVI-6992, available from The Dow Chemical Company) by a rotation and revolution type centrifugal mixing apparatus (product name: AWATORI RENTARO (registered trade name), available from Thinky Corporation).

The viscosity of the epoxy resin composition (3) for core layers was measured at a temperature of 23° C. using a rheometer (product name: RC20-CPS, available from Rheotec Co., Ltd.) and found to be 690 mPa·s. Further, the refractive index of the epoxy resin composition (3) for core layers after curing obtained under the curing conditions which were the same as those of Example 1 described below was measured at a wavelength of 830 nm using a prism coupler (product name: SPA-4000, available from SAIRON TECHNOLOGY, INC.) and found to be 1.55.

<<Preparation of Polyamide Acid Composition (1) for Substrates>>

A 50-mL three-neck flask was charged with 1.80 g (10.0 mmol) of 2,4,5,6-tetrafluoro-1,3-diaminobenzene, 5.82 g (10.0 mmol) of 4,4′-[(2,3,5,6-tetrafluoro-1,4-phenylene)bis(oxy)]bis(3,5,6-trifluorophthalic anhydride) (i.e., 1,4-bis(3,4-dicarboxytrifluorophenoxy)tetrafluro-benzene)dianhydride represented by the following formula (2):

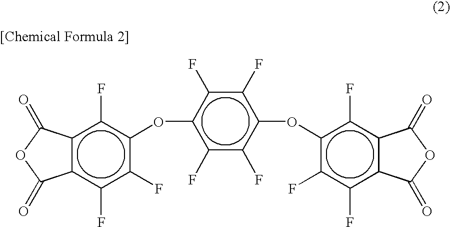

and 12.4 g of N,N-dimethylacetamide. The mixed solution was stirred at room temperature for 6 days in a nitrogen atmosphere to obtain a polyamide acid composition (1) for substrates, having a solid content of 38.0% by mass.

<<Preparation of Polyamide Acid Composition (2) for Substrates>>

A 50-mL three-neck flask was charged with 2.00 g (10.0 mmol) of 4,4′-diaminodiphenyl ether, 2.18 g (10.0 mmol) of pyromellitic anhydride, and 9.75 g of N-methyl-2-pyrrolidinone. The mixed solution was stirred at 50° C. for 6 hours in a nitrogen atmosphere to obtain a polyamide acid composition (2) for substrates, having a solid content of 30.0% by mass.

<<Preparation of Polyamide Acid Composition for Cladding Layers>>

A 50-mL three-neck flask was charged with 1.80 g (10.0 mmol) of 2,4,5,6-tetrafluoro-1,3-diaminobenzene, 5.82 g (10.0 mmol) of 4,4′-[(2,3,5,6-tetrafluoro-1,4-phenylene)bis(oxy)]bis(3,5,6-trifluorophthalic anhydride) (i.e., 1,4-bis(3,4-dicarboxytrifluorophenoxy)tetrafluro-benzene dianhydride) represented by the above formula (2), and 12.4 g of N,N-dimethylacetamide. The mixed solution was stirred at room temperature for 6 days in a nitrogen atmosphere to obtain a polyamide acid composition (1) for cladding layers, having a solid content of 38.0% by mass.

Then, the following will describe Examples in which flexible optical waveguides each having a lower cladding layer, a core layer, and an upper cladding layer, all of which were composed of epoxy films were actually produced. The thickness of the lower cladding layer, the core layer, and the upper cladding layer was adjusted by spin coating at a rotation speed to give a prescribed thickness based on calibration curves previously produced from the rotation speeds of spin coating and the film thicknesses after curing.

<<Production of Flexible Optical Waveguides>>

### Example 1

First, the epoxy resin composition (1) for cladding layers was spin coated on a silicon substrate, and ultraviolet irradiation was carried out at an illumination intensity of 10 mW/cm² for 15 minutes, i.e., at an exposure energy of 9 J/cm², using an exposure apparatus (product name: MA-60F, available from Mikasa Co., Ltd.) with a high pressure mercury lamp as a light source (having a wavelength of 365 nm) to form a lower cladding layer composed of an epoxy film having a thickness of 50 μm. The refractive index of the lower cladding layer was measured at a wavelength of 830 nm using a prism coupler (product name: SPA-4000, available from SAIRON TECHNOLOGY, INC.) and found to be 1.53.

The epoxy resin composition (1) for core layers was spin coated on the resultant lower cladding layer, and ultraviolet irradiation was carried out through a photomask at an illumination intensity of 10 mW/cm² for 15 minutes, i.e., at an exposure energy of 9 J/cm², using an exposure apparatus (product name: MA-60F, available from Mikasa Co., Ltd.) with a high pressure mercury lamp as a light source (having a wavelength of 365 nm) for patterning, followed by washing away uncured portions with acetone, to form a core layer composed of an epoxy film having a size of 50 μm square. The refractive index of the core layer was measured at a wavelength of 830 nm using a prism coupler (product name: SPA-4000, available from SAIRON TECHNOLOGY, INC.) and found to be 1.58.

The epoxy resin composition (1) for cladding layers was spin coated on the lower cladding layer, including the resultant core layer, and ultraviolet irradiation was carried out at an illumination intensity of 10 mW/cm² for 15 minutes, i.e., at an exposure energy of 9 J/cm² using an exposure apparatus (product name: MA-60F, available from Mikasa Co., Ltd.) with a high pressure mercury lamp as a light source (having a wavelength of 365 nm) to form an upper cladding layer composed of an epoxy film having a thickness of 70 μm (the thickness of the upper cladding layer on the core layer was 20 μm). The refractive index of the upper cladding layer was measured at a wavelength of 830 nm using a prism coupler (product name: SPA-4000, available from SAIRON TECHNOLOGY, INC.) and found to be 1.53.

The resultant three-layer film was separated from the silicon substrate to obtain a flexible optical waveguide (1) having the lower cladding layer, the core layer, and the upper cladding layer, all of which were composed of epoxy films.

When the waveguide loss of the resultant flexible optical waveguide (1) was measured without being bent, it was 0.12 dB/cm. Further, using the resultant flexible optical waveguide (1), the waveguide loss at the time of being bent at 90 degrees with a radius of 10 mm was measured according to the test method of polymer waveguides (7.1.1 Bending Test JPCA-PE02-05-01S) published by Japan Printed Circuit Association and found to be the same as the waveguide loss measured without being bent, and no increase of waveguide loss was observed. Further, when waveguide loss was measured in a state that the flexible optical waveguide (1) was bent at 90 degrees with a radius of 10 mm and then turned back to the previous state, the waveguide loss measured in such a state was found to be not changed from the waveguide loss measured before being bent.

### Example 2

A flexible optical waveguide (2) having a lower cladding layer, a core layer, and an upper cladding layer, all of which were composed of epoxy films, was obtained in the same manner as described in Example 1, except that the epoxy resin composition (2) for cladding layers was used in place of the epoxy resin composition (1) for cladding layers at the time of forming the upper cladding layer.

When the waveguide loss of the resultant flexible optical waveguide (2) was measured without being bent, it was 0.13 dB/cm. Further, using the resultant flexible optical waveguide (2), the waveguide loss at the time of being bent at 90 degrees with a radius of 10 mm was measured according to the test method of polymer waveguides (7.1.1 Bending Test JPCA-PE02-05-01S) published by Japan Printed Circuit Association and found to be the same as the waveguide loss measured without being bent, and no increase of waveguide loss was observed. Further, when waveguide loss was measured in a state that the flexible optical waveguide (2) was bent at 90 degrees with a radius of 10 mm and then turned back to the previous state, the waveguide loss measured in such a state was found to be not changed from the waveguide loss measured before being bent.

### Example 3

A flexible optical waveguide (3) having a lower cladding layer, a core layer, and an upper cladding layer, all of which were composed of epoxy films, was obtained in the same manner as described in Example 1, except that the epoxy resin composition (2) for cladding layers was used in place of the epoxy resin composition (1) for cladding layers at the time of forming the lower cladding layer.

When the waveguide loss of the resultant flexible optical waveguide (3) was measured without being bent, it was 0.13 dB/cm. Further, using the resultant flexible optical waveguide (3), the waveguide loss at the time of being bent at 90 degrees with a radius of 10 mm was measured according to the test method of polymer waveguides (7.1.1 Bending Test JPCA-PE02-05-01S) published by Japan Printed Circuit Association and found to be the same as the waveguide loss measured without being bent, and no increase of waveguide loss was observed. Further, when waveguide loss was measured in a state that the flexible optical waveguide (3) was bent at 90 degrees with a radius of 10 mm and then turned back to the previous state, the waveguide loss measured in such a state was found to be not changed from the waveguide loss measured before being bent.

### Example 4

A flexible optical waveguide (4) having a lower cladding layer, a core layer, and an upper cladding layer, all of which were composed of epoxy films, was obtained in the same manner as described in Example 1, except that the epoxy resin composition (2) for cladding layers was used in place of the epoxy resin composition (1) for cladding layers at the time of forming both the upper cladding layer and the lower cladding layer.

When the waveguide loss of the resultant flexible optical waveguide (4) was measured without being bent, it was 0.11 dB/cm. Further, using the resultant flexible optical waveguide (4), the waveguide loss at the time of being bent at 90 degrees with a radius of 10 mm was measured according to the test method of polymer waveguides (7.1.1 Bending Test JPCA-PE02-05-01S) published by Japan Printed Circuit Association and found to be the same as the waveguide loss measured without being bent, and no increase of waveguide loss was observed. Further, when waveguide loss was measured in a state that the flexible optical waveguide (4) was bent at 90 degrees with a radius of 10 mm and then turned back to the previous state, the waveguide loss measured in such a state was found to be not changed from the waveguide loss measured before being bent.

### Example 5

A flexible optical waveguide (5) having a lower cladding layer, a core layer, and an upper cladding layer, all of which were composed of epoxy films, was obtained in the same manner as described in Example 1, except that the epoxy resin composition (4) for cladding layers was used in place of the epoxy resin composition (1) for cladding layers at the time of forming the lower cladding layer.

When the waveguide loss of the resultant flexible optical waveguide (5) was measured without being bent, it was 0.11 dB/cm. Further, using the resultant flexible optical waveguide (5), the waveguide loss at the time of being bent at 90 degrees with a radius of 10 mm was measured according to the test method of polymer waveguides (7.1.1 Bending Test JPCA-PE02-05-01S) published by Japan Printed Circuit Association and found to be the same as the waveguide loss measured without being bent, and no increase of waveguide loss was observed. Further, when waveguide loss was measured in a state that the flexible optical waveguide (5) was bent at 90 degrees with a radius of 10 mm and then turned back to the previous state, the waveguide loss measured in such a state was found to be not changed from the waveguide loss measured before being bent.

### Example 6

The surface of a silicon substrate (having a width of 5 cm and a length of 5 cm) was diced to form forty grooves having a width of 50 μm and a depth of 50 μm at an interval of 1 mm, and a first mold was thus produced. The dicing conditions were shown below.

Dicing Conditions:

Automatic dicing saw DAD321, available from DISCO Corporation;

Blade: NBC-Z 2030;

Feeding speed: 1 mm/min;

Blade rotating speed: 30,000 rpm;

Cutting water: blade/shower=1/1 (L/min).

Then, a two-component mixed type silicone resin (available from Shin-Etsu Chemical Co., Ltd.) was coated on the first mold and allowed to stand still at room temperature for 24 hours so that the silicone resin was cured, and a second mold composed of silicone rubber for cladding layer formation was thus produced. At that time, a peeling agent (a 0.2 wt % solution obtained by dissolving product name: TEFLON (registered trade name) AF1600 (available from SIGMA-ALDRICH•Corporation) in product name: Fluorinert (registered trade name) (available from 3M Company)) was coated on the first mold by a spin coater to make easy the separation of the resultant second mold from the first mold and to transfer a fine groove pattern to the second mold.

Then, the second mold was put on a substrate with a spacer interposed therebetween, into which an appropriate amount of the epoxy resin composition (3) for cladding layers was cast, and ultraviolet irradiation was carried out from the upper side of the second mold to make the epoxy resin composition (3) cured. Then, the second mold and the spacer were removed to form a grooved lower cladding layer composed of an epoxy film on the substrate. The thickness of the portions of the lower cladding layer excluding the grooves for core layers was 70 μm. The refractive index of the lower cladding layer was measured at a wavelength of 830 nm using a prism coupler (product name: SPA-4000, available from SAIRON TECHNOLOGY, INC.) and found to be 1.50.

The epoxy resin composition (2) for core layers was cast into the resultant grooved lower cladding layer to fill the grooves of the lower cladding layer, and curing was carried out by ultraviolet irradiation to form a core layer composed of an epoxy film having a size of 50 μm square. The refractive index of the core layer was measured at a wavelength of 830 nm using a prism coupler (product name: SPA-4000, available from SAIRON TECHNOLOGY, INC.) and found to be 1.55.

Finally, the epoxy resin composition (3) for cladding layers was spin coated on the side of the lower cladding layer in which the core layer was formed, and curing was carried out by ultraviolet irradiation to form an upper cladding layer composed of an epoxy film having a thickness of 10 μm. The refractive index of the upper cladding layer was measured at a wavelength of 830 nm using a prism coupler (product name: SPA-4000, available from SAIRON TECHNOLOGY, INC.) and found to be 1.50.

The curing of the epoxy resin compositions was carried out at an illumination intensity of 10 mW/cm² for 15 minutes, i.e., at an exposure energy of 9 J/cm², using an exposure apparatus (product name: MA-60F, available from Mikasa Co., Ltd.) with a high pressure mercury lamp as a light source (having a wavelength of 365 nm).

The resultant three-layer film was separated from the substrate to obtain a flexible optical waveguide (6) having the lower cladding layer, the core layer, and the upper cladding layer, all of which were composed of epoxy films.

When the waveguide loss of the resultant flexible optical waveguide (6) was measured without being bent, it was 0.08 dB/cm. Further, using the resultant flexible optical waveguide (6), the waveguide loss at the time of being bent at 90 degrees with a radius of 10 mm was measured according to the test method of polymer waveguides (7.1.1 Bending Test JPCA-PE02-05-01S) published by Japan Printed Circuit Association and found to be the same as the waveguide loss measured without being bent, and no increase of waveguide loss was observed. Further, when waveguide loss was measured in a state that the flexible optical waveguide (6) was bent at 90 degrees with a radius of 10 mm and then turned back to the previous state, the waveguide loss measured in such a state was found to be not changed from the waveguide loss measured before being bent.

<<Evaluation>>

As described above, the flexible optical waveguides of Examples 1 to 6 were all excellent in flexibility and durable to bending, and no increase of waveguide loss was observed even when being bent at 90 degrees with a radius of 10 mm as compared with the case when not being bent. Further, when waveguide loss was measured in a state that these flexible optical waveguides were bent at 90 degrees with a radius of 10 mm and then turned back to the previous state, the waveguide loss measured in such a state was not changed from the waveguide loss measured before being bent. Further, the epoxy films constituting the lower cladding layer and the upper cladding layer and the epoxy film constituting the core layer had a sufficient difference in refractive index for functioning as optical waveguides, and in addition, the waveguide loss measured by forming the waveguide end faces was sufficiently low, and therefore, these flexible optical waveguides were practically usable flexible optical waveguides.

Thus, it can be understood that if each of a lower cladding layer, a core layer, and an upper cladding layer are composed of an epoxy film formed using an epoxy resin composition containing a polyglycidyl compound having a polyalkylene glycol chain(s) and at least two glycidyl groups, it becomes possible to obtain flexible optical waveguides which are excellent in flexibility and durable to bending and show no increase of waveguide loss by being bent at 90 degrees with a radius of 10 mm as compared with the case when not being bent and also show the same waveguide loss as that before being bent in the case where waveguide loss is measured in a state that the flexible optical waveguides are bent at 90 degrees with a radius of 10 mm and then turned back to the previous state. Further, it can be understood that if a method of forming an optical waveguide film on a base material and then separating the optical waveguide film from the base material is employed, flexible optical waveguides can easily be produced. Further, it can be understood that if the mixing ratio of a polyglycidyl compound having a polyalkylene glycol chain(s) and at least two glycidyl groups and the mixing ratio(s) of a bisphenol type epoxy resin and/or an alicyclic epoxy resin to be contained, if necessary, are changed, epoxy resin compositions for flexible optical waveguides giving epoxy films having refractive indexes arbitrarily adjusted in a prescribed range can be obtained.

Then, the following will describe Examples and Comparative Examples in which flexible optical waveguides each having a lower cladding layer, a core layer, and an upper cladding layer, all of which were composed of epoxy films, on a substrate composed of a polyimide film were actually produced. The thickness of the substrate, the lower cladding layer, the core layer, and the upper cladding layer was adjusted by spin coating at a rotation speed to give a prescribed thickness based on calibration curves previously produced from the rotation speeds of spin coating and the film thicknesses after curing.

<<Production of Flexible Optical Waveguides>>

### Example 7

First, the polyamide acid composition (1) for substrates was dropped on a silicon substrate to form a film by spin coating technique. This coated film was subjected to continuous heat treatment in a baking furnace at 320° C. purged with nitrogen to form a polyimide film having a thickness of 50 μm as a substrate.

Then, the epoxy resin composition (1) for cladding layers was spin coated on the resultant polyimide film, and ultraviolet irradiation was carried out at an illumination intensity of 10 mW/cm² for 15 minutes, i.e., at an exposure energy of 9 J/cm², using an exposure apparatus (product name: MA-60F, available from Mikasa Co., Ltd.) with a high pressure mercury lamp as a light source (having a wavelength of 365 nm) to form a lower cladding layer composed of an epoxy film having a thickness of 50 μm. The refractive index of the lower cladding layer was measured at a wavelength of 830 nm using a prism coupler (product name: SPA-4000, available from SAIRON TECHNOLOGY, INC.) and found to be 1.53.

At this stage, adhesiveness between the substrate (polyimide film) and the lower cladding layer (epoxy film) was evaluated by a cross-cut tape test (old JIS K5400). That is, a lattice of 100 cross-cuts each having a size of 1 mm×1 mm was formed by a cutter in the epoxy film formed on the polyimide film, and a commercially available adhesive tape (Cellotape (registered trade name), available from Nichiban Co., Ltd.) was attached to the lattice, after which the adhesive tape was forcibly peeled off by a hand and the number of the squares which were not separated was counted for evaluation. The result was 100/100 and it showed excellent adhesiveness.

The epoxy resin composition (1) for core layers was spin coated on the resultant lower cladding layer, and ultraviolet irradiation was carried out through a photomask at an illumination intensity of 10 mW/cm² for 15 minutes, i.e., at an exposure energy of 9 J/cm², using an exposure apparatus (product name: MA-60F, available from Mikasa Co., Ltd.) with a high pressure mercury lamp as a light source (having a wavelength of 365 nm) for patterning, followed by washing away uncured portions with acetone, to form a core layer composed of an epoxy film having a size of 50 μm square. The refractive index of the core layer was measured at a wavelength of 830 nm using a prism coupler (product name: SPA-4000, available from SAIRON TECHNOLOGY, INC.) and found to be 1.58.

The epoxy resin composition (1) for cladding layers was spin coated on the lower cladding layer, including the resultant core layer, and ultraviolet irradiation was carried out at an illumination intensity of 10 mW/cm² for 15 minutes, i.e., at an exposure energy of 9 J/cm² using an exposure apparatus (product name: MA-60F, available from Mikasa Co., Ltd.) with a high pressure mercury lamp as a light source (having a wavelength of 365 nm) to form an upper cladding layer composed of an epoxy film having a thickness of 70 μm (the thickness of the upper cladding layer on the core layer was 20 μm). The refractive index of the upper cladding layer was measured at a wavelength of 830 nm using a prism coupler (product name: SPA-4000, available from SAIRON TECHNOLOGY, INC.) and found to be 1.53.

The resultant four-layer film was separated from the silicon substrate to obtain a flexible optical waveguide (7) having the lower cladding layer, the core layer, and the upper cladding layer, all of which were composed of epoxy films, on the substrate composed of a polyimide film.

When the waveguide loss of the resultant flexible optical waveguide (7) was measured, it was 0.13 dB/cm. Further, when the resultant flexible optical waveguide (7) was bent at 180 degrees with a radius of 1 mm, no cracks were formed in all of four layers and the optical waveguide film was not changed in appearance before and after the bending. Further, when the flexible optical waveguide (7) was evaluated for wet heat resistance, no changes in appearance, such as separation, were observed, and adhesiveness between the substrate and the optical waveguide film was found to be excellent, and high wet heat resistance was exhibited.

### Example 8

A flexible optical waveguide (8) having a lower cladding layer, a core layer, and an upper cladding layer, all of which were composed of epoxy films, on a substrate composed of a polyimide film was obtained in the same manner as described in Example 7, except that the epoxy resin composition (2) for cladding layers was used in place of the epoxy resin composition (1) for cladding layers at the time of forming the upper cladding layer.

At the stage where the lower cladding layer (epoxy film) was formed on the substrate (polyimide film), adhesiveness between the substrate (polyimide film) and the lower cladding layer (epoxy film) was evaluated by a cross-cut tape test (old JIS K5400) in the same manner as described in Example 7. The result was 100/100 and it showed excellent adhesiveness.

When the waveguide loss of the resultant flexible optical waveguide (8) was measured, it was 0.14 dB/cm. Further, when the resultant flexible optical waveguide (8) was bent at 180 degrees with a radius of 1 mm, no cracks were formed in all of four layers and the optical waveguide film was not changed in appearance before and after the bending. Further, when the flexible optical waveguide (8) was evaluated for wet heat resistance, no changes in appearance, such as separation, were observed, and adhesiveness between the substrate and the optical waveguide film was found to be excellent, and high wet heat resistance was exhibited.

### Example 9

A flexible optical waveguide (9) having a lower cladding layer, a core layer, and an upper cladding layer, all of which were composed of epoxy films, on a substrate composed of a polyimide film was obtained in the same manner as described in Example 7, except that the epoxy resin composition (2) for cladding layers was used in place of the epoxy resin composition (1) for cladding layers at the time of forming the lower cladding layer.

At the stage where the lower cladding layer (epoxy film) was formed on the substrate (polyimide film), adhesiveness between the substrate (polyimide film) and the lower cladding layer (epoxy film) was evaluated by a cross-cut tape test (old JIS K5400) in the same manner as described in Example 7. The result was 100/100 and it showed excellent adhesiveness.

When the waveguide loss of the resultant flexible optical waveguide (9) was measured, it was 0.15 dB/cm. Further, when the resultant flexible optical waveguide (9) was bent at 180 degrees with a radius of 1 mm, no cracks were formed in all of four layers, and the optical waveguide film was not changed in appearance before and after the bending. Further, when the flexible optical waveguide (9) was evaluated for wet heat resistance, no changes in appearance, such as separation, were observed, and adhesiveness between the substrate and the optical waveguide film was found to be excellent, and high wet heat resistance was exhibited.

### Example 10

A flexible optical waveguide (10) having a lower cladding layer, a core layer, and an upper cladding layer, all of which were composed of epoxy films, on a substrate composed of a polyimide film was obtained in the same manner as described in Example 7, except that the epoxy resin composition (2) for cladding layers was used in place of the epoxy resin composition (1) for cladding layers at the time of forming both the lower cladding layer and the upper cladding layer.

At the stage where the lower cladding layer (epoxy film) was formed on the substrate (polyimide film), adhesiveness between the substrate (polyimide film) and the lower cladding layer (epoxy film) was evaluated by a cross-cut tape test (old JIS K5400) in the same manner as described in Example 7. The result was 100/100 and it showed excellent adhesiveness.

When the waveguide loss of the resultant flexible optical waveguide (10) was measured, it was 0.13 dB/cm. Further, when the resultant flexible optical waveguide (10) was bent at 180 degrees,with a radius of 1 mm, no cracks were formed in all of four layers, and the optical waveguide film was not changed in appearance before and after the bending. Further, when the flexible optical waveguide (10) was evaluated for wet heat resistance, no changes in appearance, such as separation, were observed, and adhesiveness between the substrate and the optical waveguide film was found to be excellent, and high wet heat resistance was exhibited.

### Example 11

A flexible optical waveguide (11) having a lower cladding layer, a core layer, and an upper cladding layer, all of which were composed of epoxy films, on a substrate composed of a polyimide film was obtained in the same manner as described in Example 7, except that the epoxy resin composition (4) for cladding layers was used in place of the epoxy resin composition (1) for cladding layers at the time of forming the lower cladding layer.

At the stage where the lower cladding layer (epoxy film) was formed on the substrate (polyimide film), adhesiveness between the substrate (polyimide film) and the lower cladding layer (epoxy film) was evaluated by a cross-cut tape test (old JIS K5400) in the same manner as described in Example 7. The result was 100/100 and it showed excellent adhesiveness.

When the waveguide loss of the resultant flexible optical waveguide (11) was measured, it was 0.11 dB/cm. Further, when the resultant flexible optical waveguide (11) was bent at 180 degrees with a radius of 1 mm, no cracks were formed in all of four layers, and the optical waveguide film was not changed in appearance before and after the bending. Further, when the flexible optical waveguide (11) was evaluated for wet heat resistance, no changes in appearance, such as separation, were observed, and adhesiveness between the substrate and the optical waveguide film was found to be excellent, and high wet heat resistance was exhibited.

### Example 12

A flexible optical waveguide (12) having a lower cladding layer, a core layer, and an upper cladding layer, all of which were composed of epoxy films, on a substrate composed of a polyimide film was obtained in the same manner as described in Example 7, except that the polyamide acid composition (2) for substrates was used in place of the polyamide acid composition (1) for substrates at the time of forming the polyimide film as the substrate.

At the stage where the lower cladding layer (epoxy film) was formed on the substrate (polyimide film), adhesiveness between the substrate (polyimide film) and the lower cladding layer (epoxy film) was evaluated by a cross-cut tape test (old JIS K5400) in the same manner as described in Example 7. The result was 100/100 and it showed excellent adhesiveness.

When the waveguide loss of the resultant flexible optical waveguide (12) was measured, it was 0.15 dB/cm. Further, when the resultant flexible optical waveguide (12) was bent at 180 degrees with a radius of 1 mm, no cracks were formed in all of four layers, and the optical waveguide film was not changed in appearance before and after the bending. Further, when the flexible optical waveguide (12) was evaluated for wet heat resistance, no changes in appearance, such as separation, were observed, and adhesiveness between the substrate and the optical waveguide film was found to be excellent, and high wet heat resistance was exhibited.

### Example 13

A flexible optical waveguide (13) having a lower cladding layer, a core layer, and an upper cladding layer, all of which were composed of epoxy films, on a substrate composed of a polyimide film was obtained in the same manner as described in Example 7, except that the polyamide acid composition (2) for substrates was used in place of the polyamide acid composition (1) for substrates at the time of forming the polyimide film as the substrate and the epoxy resin composition (2) for cladding layers was used in place of the epoxy resin composition (1) for cladding layers at the time of forming the upper cladding layer.

At the stage where the lower cladding layer (epoxy film) was formed on the substrate (polyimide film), adhesiveness between the substrate (polyimide film) and the lower cladding layer (epoxy film) was evaluated by a cross-cut tape test (old JIS K5400) in the same manner as described in Example 7. The result was 100/100 and it showed excellent adhesiveness.

When the waveguide loss of the resultant flexible optical waveguide (13) was measured, it was 0.19 dB/cm. Further, when the resultant flexible optical waveguide (13) was bent at 180 degrees with a radius of 1 mm, no cracks were formed in all of four layers, and the optical waveguide film was not changed in appearance before and after the bending. Further, when the flexible optical waveguide (13) was evaluated for wet heat resistance, no changes in appearance, such as separation, were observed, and adhesiveness between the substrate and the optical waveguide film was found to be excellent, and high wet heat resistance was exhibited.

### Example 14

A flexible optical waveguide (14) having a lower cladding layer, a core layer, and an upper cladding layer, all of which were composed of epoxy films, on a substrate composed of a polyimide film was obtained in the same manner as described in Example 7, except that the polyamide acid composition (2) for substrates was used in place of the polyamide acid composition (1) for substrates at the time of forming the polyimide film as the substrate and the epoxy resin composition (2) for cladding layers was used in place of the epoxy resin composition (1) for cladding layers at the time of forming the lower cladding layer.

At the stage where the lower cladding layer (epoxy film) was formed on the substrate (polyimide film), adhesiveness between the substrate (polyimide film) and the lower cladding layer (epoxy film) was evaluated by a cross-cut tape test (old JIS K5400) in the same manner as described in Example 7. The result was 100/100 and it showed excellent adhesiveness:

When the waveguide loss of the resultant flexible optical waveguide (14) was measured, it was 0.18 dB/cm. Further, when the resultant flexible optical waveguide (14) was bent at 180 degrees with a radius of 1 mm, no cracks were formed in all of four layers, and the optical waveguide film was not changed in appearance before and after the bending. Further, when the flexible optical waveguide (14) was evaluated for wet heat resistance, no changes in appearance, such as separation, were observed, and adhesiveness between the substrate and the optical waveguide films was found to be excellent, and high wet heat resistance was exhibited.

### Example 15

A flexible optical waveguide (15) having a lower cladding layer, a core layer, and an upper cladding layer, all of which were composed of epoxy films, on a substrate composed of a polyimide film was obtained in the same manner as described in Example 7, except that the polyamide acid composition (2) for substrates was used in place of the polyamide acid composition (1) for substrates at the time of forming the polyimide film as the substrate and the epoxy resin composition (2) for cladding layers was used in place of the epoxy resin composition (1) for cladding layers at the time of forming both the lower cladding layer and the upper cladding layer.

At the stage where the lower cladding layer (epoxy film) was formed on the substrate (polyimide film), adhesiveness between the substrate (polyimide film) and the lower cladding layer (epoxy film) was evaluated by a cross-cut tape test (old JIS K5400) in the same manner as described in Example 7. The result was 100/100 and it showed excellent adhesiveness.

When the waveguide loss of the resultant flexible optical waveguide (15) was measured, it was 0.16 dB/cm. Further, when the resultant flexible optical waveguide (15) was bent at 180 degrees with a radius of 1 mm, no cracks were formed in all of four layers, and the optical waveguide film was not changed in appearance before and after the bending. Further, when the flexible optical waveguide (15) was evaluated for wet heat resistance, no changes in appearance, such as separation, were observed, and adhesiveness between the substrate and the optical waveguide film was found to be excellent, and high wet heat resistance was exhibited.

### Example 16

A flexible optical waveguide (16) having a lower cladding layer and a core layer, both of which were composed of epoxy films, and an upper cladding layer composed of a polyimide film on a substrate composed of a polyimide film was obtained in the same manner as described in Example 7, except that the polyamide acid composition for cladding layers was used in place of the polyamide acid composition (1) for cladding layers at the time of forming the upper cladding layer and the coated film was subjected to continuous heat treatment in a baking furnace at 250° C. purged with nitrogen.

When the waveguide loss of the resultant flexible optical waveguide (16) was measured, it was 0.22 dB/cm. Further, when the resultant flexible optical waveguide (16) was bent at 180 degrees with a radius of 1 mm, no cracks were formed in all of four layers, and the optical waveguide film was not changed in appearance before and after the bending. Further, when the flexible optical waveguide (16) was evaluated for wet heat resistance, no changes in appearance, such as separation, were observed, and adhesiveness between the substrate and the optical waveguide film was found to be excellent, and high wet heat resistance was exhibited.

### Example 17

The surface of a silicon substrate (having a width of 5 cm and a length of 5 cm) was diced to form forty grooves having a width of 50 μm and a depth of 50 μm at and interval of 1 mm, and a first mold was thus produced. The dicing conditions were shown below.

Dicing Conditions:

Automatic dicing saw DAD321, available from DISCO Corporation;

Blade: NBC-Z 2030;

Feeding speed: 1 mm/min;

Blade rotating speed: 30,000 rpm;

Cutting water: blade/shower=1/1 (L/min).

Then, a two-component mixed type silicone resin (available from Shin-Etsu Chemical Co., Ltd.) was coated on the first mold and allowed to stand still at room temperature for 24 hours so that the silicone resin was cured, and a second mold composed of silicone rubber for cladding layer formation was thus produced. At that time, a peeling agent (a 0.2 wt % solution obtained by dissolving product name: TEFLON (registered trade name) AF1600 (available from SIGMA-ALDRICH Corporation) in product name: Fluorinert (registered trade name) (available from 3M Company)) was coated on the first mold by a spin coater to make easy the separation of the resultant second mold from the first mold and to transfer a fine groove pattern to the second mold.

On the other hand, the polyamide acid composition (2) for substrates was dropped on another silicon substrate (having a width of 5 cm and a length of 5 cm) to form a film by spin coating technique. This coated film was subjected to continuous heat treatment in a baking furnace at 320° C. purged with nitrogen to form a polyimide film having a thickness of 50 μm as a substrate.

Then, the second mold was put on the polyimide film formed on another silicon substrate with a spacer interposed therebetween, into which an appropriate amount of the epoxy resin composition (3) for cladding layers was cast, and ultraviolet irradiation was carried out from the upper side of the second mold to make the epoxy resin composition (3) cured. Then, the second mold and the spacer were removed to form a grooved lower cladding layer composed of an epoxy film on the substrate. The thickness of the portions of the lower cladding layer excluding the grooves for the core layers was 70 μm. The refractive index of the lower cladding layer was measured at a wavelength of 830 nm using a prism coupler (product name: SPA-4000, available from SAIRON TECHNOLOGY, INC.) and found to be 1.50.

The epoxy resin composition (2) for core layers was cast into the resultant grooved lower cladding layer to fill the grooves of the lower cladding layer, and curing was carried out by ultraviolet irradiation to form a core layer composed of an epoxy film having a 50 μm square. The refractive index of the core layer was measured at a wavelength of 830 nm using a prism coupler (product name: SPA-4000, available from SAIRON TECHNOLOGY, INC.) and found to be 1.55.

Finally, the epoxy resin composition (3) for cladding layers was spin coated on the side of the lower cladding layer in which the core layer was formed, and curing was carried out by ultraviolet irradiation to form an upper cladding layer composed of an epoxy film having a thickness of 10 μm. The refractive index of the upper cladding layer was measured at a wavelength of 830 nm using a prism coupler (product name: SPA-4000, available from SAIRON TECHNOLOGY, INC.) and found to be 1.50.

The curing of the epoxy resin compositions was carried out at an illumination intensity of 10 mW/cm² for 15 minutes, i.e., at an exposure energy of 9 J/cm², using an exposure apparatus (product name: MA-60F, available from Mikasa Co., Ltd.) with a high pressure mercury lamp as a light source (having a wavelength of 365 nm).

The resultant four-layer films were separated from the silicon substrate to obtain a flexible optical waveguide (17) having the lower cladding layer, the core layer, and the upper cladding layer, all of which were composed of epoxy films, on the substrate composed of the polyimide film.

When the waveguide loss of the resultant flexible optical waveguide (17) was measured without being bent, it was 0.12 dB/cm. Further, when the resultant flexible optical waveguide (17) was bent at 180 degrees with a radius of 1 mm, no cracks were formed in all of four layers and the optical waveguide film was not changed in appearance before and after the bending. Further, when the flexible optical waveguide (17) was evaluated for wet heat resistance, no changes in appearance, such as separation, were observed, and adhesiveness between the substrate and the optical waveguide film was found to be excellent, and high wet heat resistance was exhibited.

### Example 18

The epoxy resin composition (1) for cladding layers, having a refractive index of 1.53 at a wavelength of 830 nm, was spin coated on a polyimide film (product name: Kapton (registered trade name), available from DuPont-Toray Co., Ltd.) having a thickness of 25 μm, a length of 100 mm, and a width of 100 mm as a substrate, and ultraviolet irradiation was carried out at an illumination intensity of 10 mW/cm² for 15 minutes, i.e., at an exposure energy of 9 J/cm², using an exposure apparatus (product name: MA-60F, available from Mikasa Co., Ltd.) with a high pressure mercury lamp as a light source (having a wavelength of 365 nm) to form a lower cladding layer composed of an epoxy film having a thickness of 25 μm.

The epoxy resin composition (1) for core layers, having a refractive index of 1.53 at a wavelength of 830 nm, was spin coated on the resultant lower cladding layer, and ultraviolet irradiation was carried out through a photomask with many light transmissible linear patterns having a line width of 50 μm and the other areas coated with Cr, at an illumination intensity of 10 mW/cm² for 15 minutes, i.e., at an exposure energy of 9 J/cm² by an exposure apparatus (product name: MA-60F, available from Mikasa Co., Ltd.) with a high pressure mercury lamp as a light source (having a wavelength of 365 nm) for patterning, followed by washing away, with acetone, uncured portions corresponding to the portions coated with Cr of the photomask, to form a core layer composed of an epoxy film with linear patterns having a width of 50 μm, a height 50 μm, and a length of 100 mm.

The epoxy resin composition (1) for cladding layers, having a refractive index of 1.58 at a wavelength of 830 nm, was spin coated on the lower cladding layer, including the resultant core layer, and ultraviolet irradiation was carried out at an illumination intensity of 10 mW/cm² for 15 minutes, i.e., at an exposure energy of 9 J/cm² by an exposure apparatus (product name: MA-60F, available from Mikasa Co., Ltd.) with a high pressure mercury lamp as-a light source (wavelength 365 nm) to form an upper cladding layer composed of an epoxy film having a thickness of 70 μm (the thickness of the upper cladding layer on the core layer was 20 μm).

In such a manner, a flexible optical waveguide (18) having the lower cladding layer, the core layer; and the upper cladding layer, all of which were composed of epoxy films, on the substrate composed of the polyimide film was obtained.

When the waveguide loss of the resultant flexible optical waveguide (18) was measured, it was 0.25 dB/cm. Further, when the resultant flexible optical waveguide (18) was bent at 180 degrees with a radius of 1 mm, no cracks were formed in all of four layers and the optical waveguide film was not changed in appearance before and after the bending. Further, when the waveguide loss was measured in a state that the flexible optical waveguide was bent at 180 degrees with a radius of 1 mm and then turned back to the previous state, it was 0.25 dB/cm, which was the same as the waveguide loss measured before being bent. Further, when the obtained flexible optical waveguide (18) was evaluated for wet heat resistance, no changes in appearance, such as separation, were observed, and adhesiveness between the substrate and the optical waveguide film was found to be excellent, and high wet heat resistance was exhibited.

### Comparative Example 1

A flexible optical waveguide (C1) having a lower cladding layer, a core layer, and an upper cladding layer, all of which were composed of epoxy films, on a substrate composed of a polyimide film with an adhesive layer interposed therebetween was obtained in the same manner as described in Example 7, except that the adhesive layer having a thickness of 10 μm was formed between the substrate (polyimide film) and the lower cladding layer (epoxy film) using an epoxy type adhesive (available from NTT Advanced Technology Corporation; the refractive index thereof was 1.53 at 850 nm).

When the waveguide loss of the resultant flexible optical waveguide (C1) was measured, it was 0.25 dB/cm. Further, when the resultant flexible optical waveguide (C1) was bent at 180 degrees with a radius of 1 mm, separation was caused between the substrate (polyimide film) and the lower cladding layer (epoxy film). Further, when the flexible, optical waveguide (C1) obtained in the same manner as described above was evaluated for wet heat resistance, foam contamination attributed to the partial separation between the substrate (polyimide film) and the lower cladding layer (epoxy film) was observed, so that the substrate (polyimide film) and the lower cladding layer (epoxy film) was able to be easily separated from each other, and therefore, adhesiveness between the substrate and the optical waveguide film was found to be inferior, and low wet heat resistance was exhibited.

### Comparative Example 2

A flexible optical waveguide (C2) having a lower cladding layer, a core layer, and an upper cladding layer, all of which were composed of epoxy films, on a substrate composed of a polyimide film with an adhesive layer interposed therebetween was obtained in the same manner as described in Example 7, except that the polyamide acid composition (2) for substrates was used in place of the polyamide acid composition (1) for substrates at the time of forming the polyimide film as the substrate and the adhesive layer having a thickness of 10 μm was formed between the substrate (polyimide film) and the lower cladding layer (epoxy film) using an epoxy type adhesive (available from NTT Advanced Technology Corporation; the refractive index there of was 1.53 at 850 nm).

When the waveguide loss of the resultant flexible optical waveguide (C1) was measured, it was 0.26 dB/cm. Further, when the resultant flexible optical waveguide (C1) was bent at 180 degrees with a radius of 1 mm, separation was caused between the substrate (polyimide film) and the lower cladding layer (epoxy film). Further, when the flexible optical waveguide (C2) obtained in the same manner as described above was evaluated as described above, foam contamination attributed to the partial separation between the substrate (polyimide film) and the lower cladding layer (epoxy film) was observed, so that the substrate (polyimide film) and the lower cladding layer (epoxy film) was able to be easily separated from each other, and therefore, adhesiveness between the substrate and the optical waveguide film was found to be inferior, and low wet heat resistance was exhibited.

<<Evaluation>>

As described above, the flexible optical waveguides of Examples 7 to 18 were all excellent in flexibility and durable to bending, and also were able to be bent at 180 degrees with a radius of 1 mm. Further, the waveguide loss measured by forming the waveguide end faces was sufficiently, low, and therefore, these flexible optical waveguides were practically usable flexible optical waveguides. Further, even after these flexible optical waveguides were allowed to stand still for a long time under high temperature and high humidity environments, adhesiveness between the substrate and the optical waveguide film was found to be excellent, and therefore, these flexible optical waveguides showed high wet heat resistance.

On the other hand, the flexible optical waveguides of Comparative Examples 1 and 2 were both inferior in flexibility and weak to bending, and when being bent at 180 degrees with a radius of 1 mm, these flexible optical waveguides was caused separation between the substrate (polyimide film) and the lower cladding layer (epoxy film). Further, the waveguide loss measured by forming waveguide end faces was relatively high, and therefore, these flexible optical waveguides were not practically usable flexible optical waveguides. Further, after these flexible optical waveguides were allowed to stand still for a long time under high temperature and high humidity environments, adhesiveness between the substrate and the optical waveguide film was inferior, and therefore, these flexible optical waveguides showed low wet heat resistance.

Thus, it can be understood that if each of a lower cladding layer, a core layer, and an upper cladding layer is composed of an epoxy film formed using an epoxy resin composition containing a polyglycidyl compound having a polyalkylene glycol chain(s) and at least two glycidyl groups, it becomes possible to obtain flexible optical waveguides which are excellent in flexibility and durable to bending, which can be bent at 180 degrees with a radius of 1 mm, and which further have high wet heat resistance, even when a polyimide film constituting a substrate is any of the heretofore known polyimide films. Further, there is no need to carry out a step of forming an adhesive layer or any other layer between a substrate and a lower cladding layer, and in addition to this, because a lower cladding layer, a core layer, and an upper cladding layer are successively formed on a substrate, flexible optical waveguides can easily be produced.

### INDUSTRIAL APPLICABILITY

The flexible optical waveguide of the present invention can be used, similarly to ordinary optical waveguides, for various optical waveguide apparatuses. The flexible optical waveguide of the present invention is excellent in flexibility and durable to bending, and therefore, optical waveguide apparatuses can be made compact. Further, with respect to the flexible optical waveguide of the present invention, in the case where an optical waveguide film is formed on a substrate composed of a polyimide film, when opto-electronic hybrid integrated flexible modules are produced from the flexible optical waveguide of the present invention, the opto-electronic hybrid integrated flexible modules can be used for various electronic equipments. The flexible optical waveguide of the present invention is excellent in flexibility of the optical waveguide film, including the substrate, as well as excellent in adhesiveness between the substrate and the optical waveguide film, and therefore, the opto-electronic hybrid integrated flexible modules can preferably be used for parts (e.g., hinge parts) required to be flexible in electronic equipments such as mobile phones, digital cameras, digital video cameras, domestic and portable game machines, notebook type personal computers, and high speed printers. Further, the flexible optical waveguide of the present invention can also be used for optical interconnection. The process for producing a flexible optical waveguide according to the present invention makes it possible to produce such a flexible optical waveguide in a simple and easy manner, and therefore, production costs can remarkably be saved. The epoxy resin composition for flexible optical waveguides according to the present invention can give an epoxy film which is excellent in flexibility and durable to bending, and therefore, it is useful for producing such a flexible optical waveguide. Accordingly, the present invention makes a great contribution to various optics related fields and electronic equipment fields, in which the applications of flexible optical waveguides are highly expected.

1. A flexible optical waveguide comprising a lower cladding layer, a core layer formed on the lower cladding layer, and an upper cladding layer formed on the lower cladding layer and the core layer in a manner of embedding the core layer therein, wherein at least one of the lower cladding layer, the core layer, and the upper cladding layer is composed of an epoxy film formed using an epoxy resin composition containing a polyglycidyl compound having a polyalkylene glycol chain(s) and at least two glycidyl groups.

2. The flexible optical waveguide according to claim 1, wherein each of the lower cladding layer, the core layer, and the upper cladding layer is composed of an epoxy film formed using an epoxy resin composition containing a polyglycidyl compound having a polyalkylene glycol chain(s) and at least two glycidyl groups.

3. The flexible optical waveguide according to claim 1, wherein the lower cladding layer is composed of an epoxy film formed using an epoxy resin composition containing a polyglycidyl compound having a polyalkylene glycol chain(s) and at least two glycidyl groups on a substrate composed of a polyimide film.

4. The flexible optical waveguide according to claim 3, wherein each of the core layer and the upper cladding layer is composed of an epoxy film formed using an epoxy resin composition containing a polyglycidyl compound having a polyalkylene glycol chain(s) and at least two glycidyl groups.

5. The flexible optical waveguide according to claim 1, wherein the polyglycidyl compound is a diglycidyl ether of polytetramethylene ether glycol.

6. A flexible optical waveguide comprising a lower cladding layer, a core layer formed on the lower cladding layer, and an upper cladding layer formed on the lower cladding layer and the core layer in a manner of embedding the core layer therein, wherein at least one of the lower cladding layer, the core layer, and the upper cladding layer is composed of an epoxy film having a glass transition temperature (Tg) of 100° C. or lower and the waveguide loss of the flexible optical waveguide is 0.24 dB/cm or lower.

7. The flexible optical waveguide according to claim 6, wherein each of the lower cladding layer, the core layer, and the upper cladding layer is composed of an epoxy film having a glass transition temperature (Tg) of 100° C. or lower.

8. The flexible optical waveguide according to claim 6, wherein the epoxy film is formed using an epoxy resin composition containing a polyglycidyl compound having a polyalkylene glycol chain(s) and at least two glycidyl groups.

9. The flexible optical waveguide according to claim 8, wherein the polyglycidyl compound is a diglycidyl ether of polytetramethylene ether glycol.

10. A process for producing a flexible optical waveguide according to claim 1, comprising steps of: forming a lower cladding layer; forming a core layer on the lower cladding layer; and forming an upper cladding layer on the lower cladding layer and the core layer in a manner of embedding the core layer therein, wherein at least one of the lower cladding layer, the core layer, and the upper cladding layer is formed using an epoxy resin composition containing a polyglycidyl compound having a polyalkylene glycol chain(s) and at least two glycidyl groups.

11. An epoxy resin composition for flexible optical waveguides, comprising a polyglycidyl compound having a polyalkylene glycol chain(s) and at least two glycidyl groups, the composition having a refractive index after curing of from 1.45 to 1.65.

12. The epoxy resin composition according to claim 11, wherein the polyglycidyl compound is a diglycidyl ether of polytetramethylene ether glycol.
